(19) United States
(12) Patent Application Publication
(10) Pub. No.: US 2018/0077207 A1
(43) Pub. Date: Mar. 15, 2018

(54) INFORMATION PROCESSING TERMINAL, COMMUNICATION SYSTEM, INFORMATION PROCESSING METHOD, AND RECORDING MEDIUM

(71) Applicants: Takeru INOUE, Kanagawa (JP); Atsuhiro FUJII, Kanagawa (JP)

(72) Inventors: Takeru INOUE, Kanagawa (JP); Atsuhiro FUJII, Kanagawa (JP)

(21) Appl. No.: 15/706,106

(22) Filed: Sep. 15, 2017

(30) Foreign Application Priority Data
Sep. 15, 2016 (JP) 2016-180058
Jul. 4, 2017 (JP) 2017-130876

(51) Int. Cl. H04L 29/06; H04N 7/15; H04N 7/14

(52) U.S. Cl. CPC H04L 65/403; H04L 65/1069; H04L 61/1594; H04N 7/147; H04N 7/15

(57) ABSTRACT

An information processing terminal, includes: a receiver to receive from a management system via a network, a candidate identifier of each one of one or more candidate counterpart information processing terminals that are previously registered for the information processing terminal; and circuitry to control a display to display a candidate list including the candidate identifiers. The circuitry determines, in response to acceptance of an identifier that has been input, whether the accepted identifier matches any one of the candidate identifiers on the candidate list. When the accepted identifier matches one of the candidate identifiers, the circuitry causes the candidate identifier that matches the accepted identifier to be displayed differently from other candidate identifies on the candidate list, such that the candidate identifier that matches the accepted identifier is noticeable.

### CROSS-REFERENCE TO RELATED APPLICATIONS

This patent application is based on and claims priority pursuant to 35 U.S.C. § 119(a) to Japanese Patent Application No. 2016-180058, filed on Sep. 15, 2016, and Japanese Patent Application No. 2017-130876, filed on Jul. 4, 2017, the entire disclosure of which is hereby incorporated by reference herein.

### BACKGROUND

### Technical Field

The present invention relates to an information processing terminal, a communication system, an information processing method, and a recording medium.

### Description of the Related Art

Conference systems are now widely used to perform a teleconference between locations distant from each other, via a communication network such as the Internet.

Among such teleconference systems, a teleconference system causes information about a plurality of terminals that are candidate communication counterparts to be displayed in the form of a candidate list on a terminal, and a user selects a counterpart terminal from the candidate list so as to start communication with the counterpart terminal easily.

### SUMMARY

Example embodiments of the present invention include an information processing terminal, includes: a receiver to receive from a management system via a network, a candidate identifier of each one of one or more candidate counterpart information processing terminals that are previously registered for the information processing terminal; and circuitry to control a display to display a candidate list including the candidate identifiers. The circuitry determines, in response to acceptance of an identifier that has been input, whether the accepted identifier matches any one of the candidate identifiers on the candidate list. When the accepted identifier matches one of the candidate identifiers, the circuitry causes the candidate identifier that matches the accepted identifier to be displayed differently from other candidate identifies on the candidate list, such that the candidate identifier that matches the accepted identifier is noticeable.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating a communication system according to an embodiment;

FIG. 2 is an illustration of a state in which image data, sound data, and various kinds of management data are transmitted and received in the communication system, according to the embodiment;

FIG. 3 is an external view of an exemplary terminal according to an embodiment;

FIG. 4 is a diagram illustrating an exemplary hardware configuration of the terminal according to an embodiment;

FIG. 5 is a diagram illustrating an exemplary hardware configuration of a management system according to an embodiment;

FIG. 6 is a diagram illustrating functional configurations of the terminal and the management system according to an embodiment;

FIGS. 7A and 7B each illustrate exemplary information managed by the management system according to an embodiment;

FIGS. 8A and 8B each illustrate exemplary information managed by the management system according to an embodiment;

FIG. 9 is a sequence diagram of an exemplary preparatory process according to an embodiment;

FIG. 10 is an illustration an example candidate list screen according to an embodiment;

FIG. 11 is a sequence diagram of an exemplary communication process according to an embodiment;

FIG. 12 is a flowchart of an exemplary terminal calling process according to a first embodiment;

FIG. 13 is an illustration of an exemplary identifier-based calling screen according to the first embodiment;

FIG. 14 is an illustration of an exemplary display screen of the terminal according to the first embodiment;

FIG. 15 is an illustration of an exemplary display screen of the terminal according to the first embodiment;

FIG. 16 is an illustration of an exemplary display screen of the terminal according to the first embodiment;

FIG. 17 is an illustration of an exemplary display screen of the terminal according to the first embodiment;

FIG. 18 is an illustration of an exemplary display screen of the terminal according to the first embodiment;

FIGS. 19A and 19B illustrate an exemplary display screen of the terminal according to the first embodiment;

FIGS. 20A and 20B (FIG. 20) are a flowchart of an exemplary terminal calling process according to a second embodiment;

FIG. 21 is a sequence diagram of an exemplary inquiry process according to the second embodiment;

FIG. 22 is an illustration of an exemplary display screen of the terminal according to the second embodiment;

FIG. 23 is an illustration of an exemplary display screen of the terminal according to the second embodiment; and

FIG. 24 is an illustration of an exemplary display screen of the terminal according to the second embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, an exemplary information processing terminal, a communication system, an information processing method, and a recording medium on which a program is recorded, each according to an embodiment of the present invention, will be described with reference to the drawings.

System Configuration

First, a system configuration of a communication system according to an embodiment will be described.

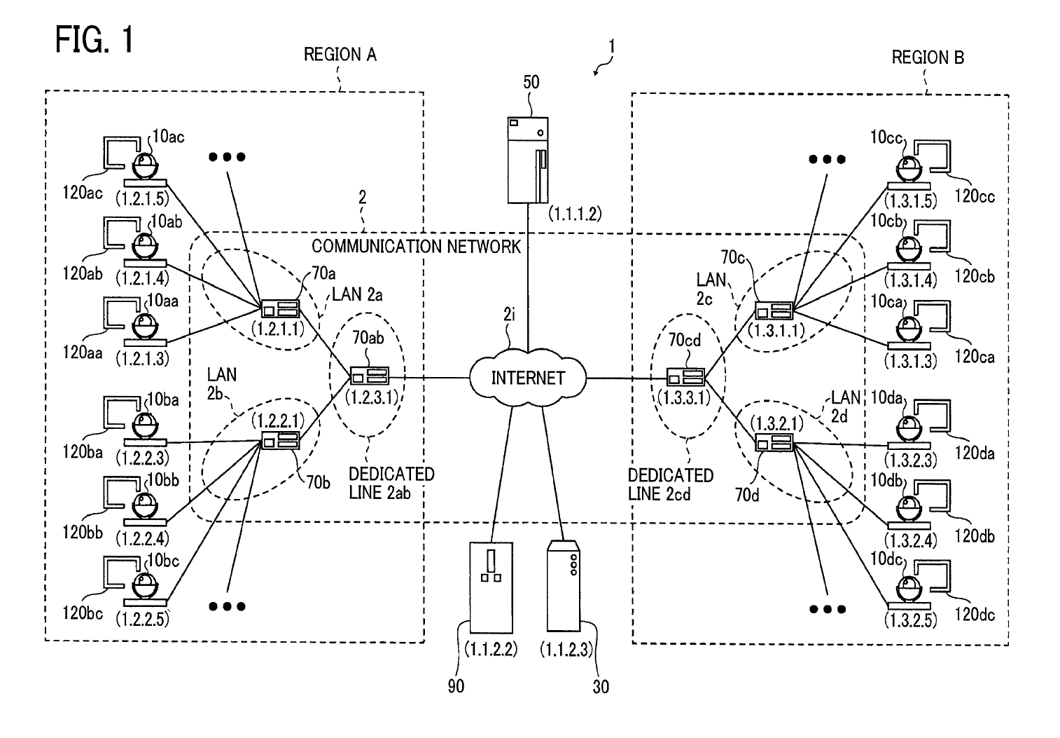

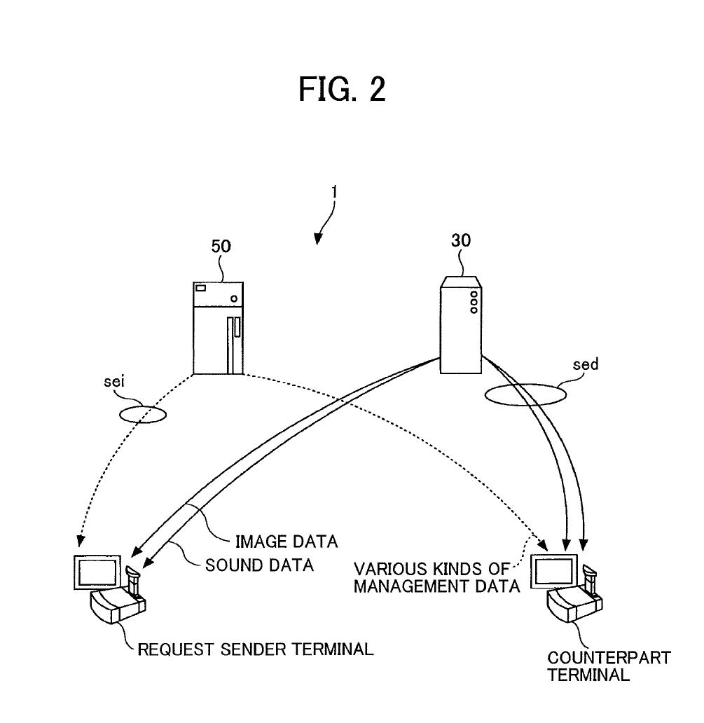

FIG. 1 schematically illustrates the communication system according to an embodiment. FIG. 2 is an illustration of a state in which image data, sound data, and various kinds of management data are transmitted and received in the communication system according to an embodiment.

The communication system includes a data providing system that transmits content data from a communication terminal to another communication terminal in one direction through a communication management apparatus. The communication system also includes a communication system and the like in which information is mutually transmitted between a plurality of communication terminals through a communication management apparatus.

This communication system is a system for mutually transmitting information between a plurality of communication terminals through a communication management system (corresponding to a “communication management apparatus”). Examples of the communication system include a videoconference system, a video telephone system, an audio conference system, an audio telephone system, a teleconference that uses a personal computer (PC) screen sharing system, and the like.

A communication system 1 illustrated in FIG. 1 includes a plurality of communication terminals (10aa, 10ab, . . . ), displays (120aa, 120ab, . . . ) for the respective communication terminals (10aa, 10ab, . . . ), a relay apparatus 30, a communication management system 50, a program providing apparatus 90, and the like.

The plurality of communication terminals (10aa, 10ab, . . . ), for example, transmit and receive content data such as video data therebetween. Examples of the video data include moving image data, still image data, sound data, and the like.

Hereinafter, the “communication management system” will simply be referred to as a “management system”, and each “communication terminal” will simply be referred to as a “terminal”. In addition, an arbitrary one or ones of the plurality of terminals (10aa, 10ab, . . . ) is/are referred to as a “terminal(s) 10”. Furthermore, an arbitrary one or ones of the plurality of displays (120aa, 120ab, . . . ) is/are referred to as a “display(s) 120”. Furthermore, a terminal serving as a request sender that requests the start of communication will be referred to as a “request sender terminal”, and a terminal serving as a counterpart (relay destination) that is the destination of the request will be referred to as a “counterpart (request destination) terminal”.

As illustrated in FIG. 2, a management-data session sei used for transmitting and receiving various kinds of management data is established via the management system 50 between the request sender terminal and the counterpart terminal in the communication system 1. In addition, for example, an image-and-sound-data session sed (communication session) used for transmitting and receiving image data and sound data is also established via the relay apparatus 30 between the request sender terminal and the counterpart terminal.

Referring back to FIG. 1, the system configuration of the communication system 1 will be further described.

Each terminal (information processing terminal) 10 transmits and receives various kinds of information to and from another terminal 10. The terminal 10, for example, establishes a communication session (image-and-sound-data session sed) with another terminal 10 and performs communication by transmitting and receiving content data including sound data, image data, and the like in the established communication session. This enables, for example, a videoconference between the plurality of terminals 10 in the communication system 1.

To start a videoconference in the communication system 1 according to an embodiment, a user who wishes to start a videoconference operates a certain terminal 10 so that the operated terminal 10 transmits start request information to the management system 50.

The start request information herein is information for requesting the start of a session for the videoconference and includes information for designating a terminal 10 as a counterpart terminal of the session.

Note that the counterpart terminal may be a single terminal 10 or two or more terminals 10. That is, in the communication system 1, a videoconference can be enabled by using a session established between, not only two terminals 10, but also three or more terminals 10.

In addition, in the communication system 1 according to an embodiment, a user can participate in a videoconference for which a session has already been established and which has already been started. A user who wishes to participate in such a videoconference operates a certain terminal 10 so that the operated terminal 10 transmits to the management system 50, participation request information designating the session that has already been established (hereinafter this session will be referred to as an established session) and used for the videoconference in which the user wishes to participate. Hereinafter, the terminal 10 that transmits the participation request information will be referred to as a “participation request terminal”.

The management system 50 is a system including an information processing apparatus or a plurality of information processing apparatuses that integrally manage the terminals 10 and the relay apparatus 30. The management system 50 establishes a communication session between the terminals 10 to enable a videoconference therebetween by communication.

Upon the start request information for a communication session being received from the request sender terminal, the management system 50 establishes a communication session between the request sender terminal and the counterpart terminal to start a videoconference. Upon the participation request information for an established session being received from the terminal 10, the management system 50 causes the participation request terminal to participate in the established session.

A plurality of routers (70a, 70b, 70c, 70d, 70ab, and 70cd) illustrated in FIG. 1 each select an optimal path for content data. Hereinafter, an arbitrary one or ones of the routers (70a, 70b, 70c, 70d, 70ab, and 70cd) will be referred to as a “router(s) 70”.

The relay apparatus 30 relays content data between the plurality of terminals 10 under control of the management system 50.

The program providing apparatus 90 includes a hard disk (HD), which will be described later, on which a terminal program is recorded for allowing each terminal 10 to implement a variety of functions and a variety of units, and the terminal program can be transmitted to the terminal 10.

The HD of the program providing apparatus 90 also stores a relay-apparatus program for allowing the relay apparatus 30 to implement a variety of functions and a variety of units, and the relay-apparatus program can be transmitted to the relay apparatus 30.

The RD of the program providing apparatus 90 further stores a communication-management program for allowing the management system 50 to implement a variety of functions and a variety of units, and the communication-management program can be transmitted to the management system 50.

The terminals (10aa, 10ab, 10ac, . . . ) are connected to the router 70a via a local area network (LAN) 2a so that communication can be performed. The terminals (10ba, 10bb, 10bc, . . . ) are connected to the router 70b via a LAN 2b so that communication can be performed. The LAN 2a and the LAN 2b are connected to each other via a dedicated line 2ab including the router 70ab and are configured within a region A so that communication can be performed. For example, the region A is Japan, the LAN 2a is configured within an office in Tokyo, and the LAN 2b is configured within an office in Osaka.

In addition, the terminals (10ca, 10cb, 10cc, . . . ) are connected to the router 70c via a LAN 2c so that communication can be performed. The terminals (10da, 10db, 10dc, . . . ) are connected to the router 70d via a LAN 2d so that communication can be performed. The LAN 2c and LAN 2d are connected to each other via a dedicated line 2cd including the router 70cd and are configured within a region B so that communication can be performed. For example, the region B is the United States, the LAN 2c is configured within an office in New York, and the LAN 2d is configured within an office in Washington D.C. The region A and the region B are connected to each other via an internet 2i from the routers (70ab and 70cd), respectively, so that communication can be performed.

The management system 50, the program providing apparatus 90, and the relay apparatus 30 are connected to the terminals 10 via the internet 2i so that communication can be performed. The management system 50, the program providing apparatus 90, and the relay apparatus 30 may be installed in the region A or the region B, or may be installed in any other region.

In the example illustrated in FIG. 1, a communication network 2 includes the LAN 2a, the LAN 2b, the dedicated line 2ab, the internet 2i, the dedicated line 2cd, the LAN 2c, and the LAN 2d. In the communication network 2, not only wired communication, but also wireless communication may be performed locally.

In the example illustrated in FIG. 1, each set of four digits below or above each of the terminals 10, the relay apparatus 30, the management system 50, each of the routers 70, and the program providing apparatus 90 represents an internet protocol (IP) address in the typical Internet Protocol version 4 (IPv4) in a simple format. For example, the IP address of the terminal 10aa is “1.2.1.3”. Although IPv6 may be used instead of IPv4, description will be given by using IPv4 for simplicity.

Hardware Configuration

Next, hardware configurations according to an embodiment will be described.

Appearance of Terminal

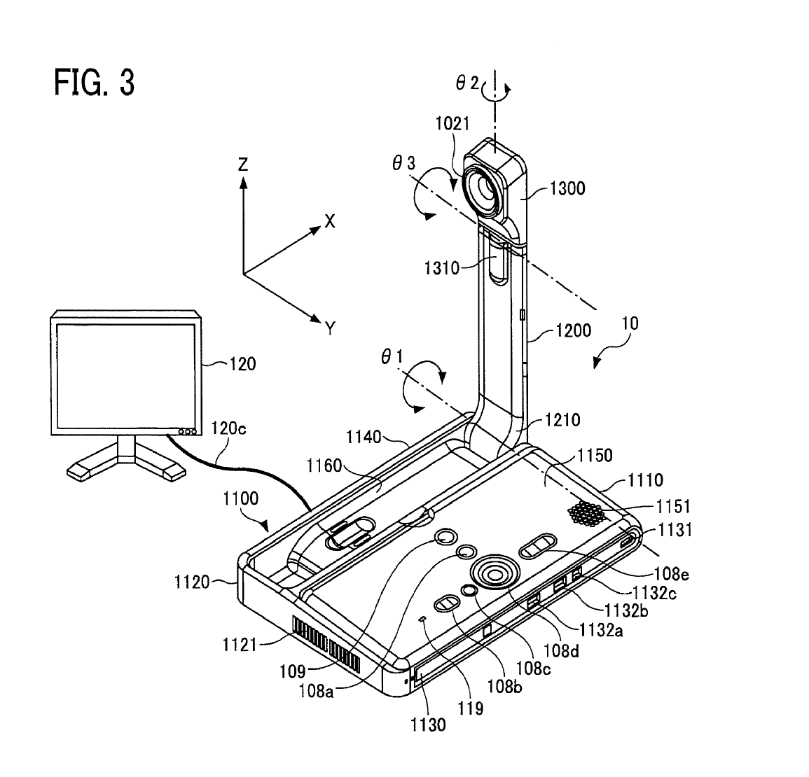

FIG. 3 is an external view of an exemplary terminal according to an embodiment. Hereinafter, the longitudinal direction of the terminal 10 will be referred to as the x-axis direction, the direction that intersects with the x-axis direction on a horizontal plane will be referred to as the y-axis direction, and the direction that intersects with the x-axis direction and the y-axis direction will be referred to as the z-axis direction (vertical direction).

As illustrated in FIG. 3, the terminal 10 includes a housing 1100, an arm 1200, and a camera housing 1300. Among these portions, a front wall 1110 of the housing 1100 has an inlet face including a plurality of inlet holes, and a rear wall 1120 of the housing 1100 has an exhaust face 1121 including a plurality of exhaust holes.

Thus, when a cooling fan that is built in the housing 1100 is driven, an air in front of the terminal 10 is taken in through the inlet face to be exhausted to the rear of the terminal 10 through the exhaust face 1121. On a right wall 1130 of the housing 1100, a sound collecting hole 1131 is formed, and a built-in microphone 114, which will be described later, can collect sounds such as voice, noise, and the like.

An operation panel 1150 is formed toward the right wall 1130 of the housing 1100. The operation panel 1150 includes a plurality of operation keys (108a to 108e), a power switch 109, and an alarm lamp 119, all of which will be described later. Further, on the operation panel 1150, a sound output face 1151 is formed with a plurality of voice output holes for transmitting sound that is output from a built-in speaker 115, which will be described later. A container 1160 for containing the arm 1200 and the camera housing 1300 is formed as a recess toward a left wall 1140 of the housing 1100. The right wall 1130 of the housing 1100 further has a plurality of connection ports (1132a to 1132c) for electrically connecting cables to an external apparatus connection interface (I/F) 118, which will be described later. On the other hand, the left wall 1140 of the housing 1100 has a connection port for electrically connecting a cable 120c for the display 120 to the external apparatus connection I/F 118, which will be described later.

Hereinafter, an arbitrary one or ones of the operation keys (108a to 108e) will be referred to as an “operation key(s) 108”, and an arbitrary one or ones of the connection ports (1132a to 1132c) will be referred to as a “connection port(s) 1132”.

The arm 1200 is coupled to the housing 1100 via a torque hinge 1210 to be rotatable in the vertical direction within a range of a tilt angle θ1 of 135 degrees with respect to the housing 1100. FIG. 3 illustrates a state in which the tilt angle θ1 is 90 degrees.

The camera housing 1300 includes a built-in camera 112, which will be described later, by which images of a user, document, room, and the like can be captured. A torque hinge 1310 is formed for the camera housing 1300, and the camera housing 1300 is coupled to the arm 1200 via the torque hinge 1310 to be rotatable in the vertical and horizontal directions within a range of a pan angle θ2 of ±180 degrees and a tilt angle θ3 of ±45 degrees, and FIG. 3 illustrates a state of 0 degrees.

As another example, the terminal 10 may be an information terminal such as a typical general computer, a tablet terminal, or a smartphone. To use an information terminal that is not equipped with a microphone or a camera as the terminal 10, an external microphone or camera is connected to the computer. Thus, the information terminal can be used as the terminal 10 according to an embodiment.

To use an information terminal as the terminal 10, an application for executing the process of the terminal 10, which will be described later, is installed in the information terminal. Accordingly, the terminal 10 is also referred to as an information processing terminal including the terminal illustrated in FIG. 3 and a typical information terminal.

Note that each of the relay apparatus 30, the management system 50, and the program providing apparatus 90 has the same appearance as a typical server computer, and therefore description thereof will be omitted.

Hardware Configuration of Terminal

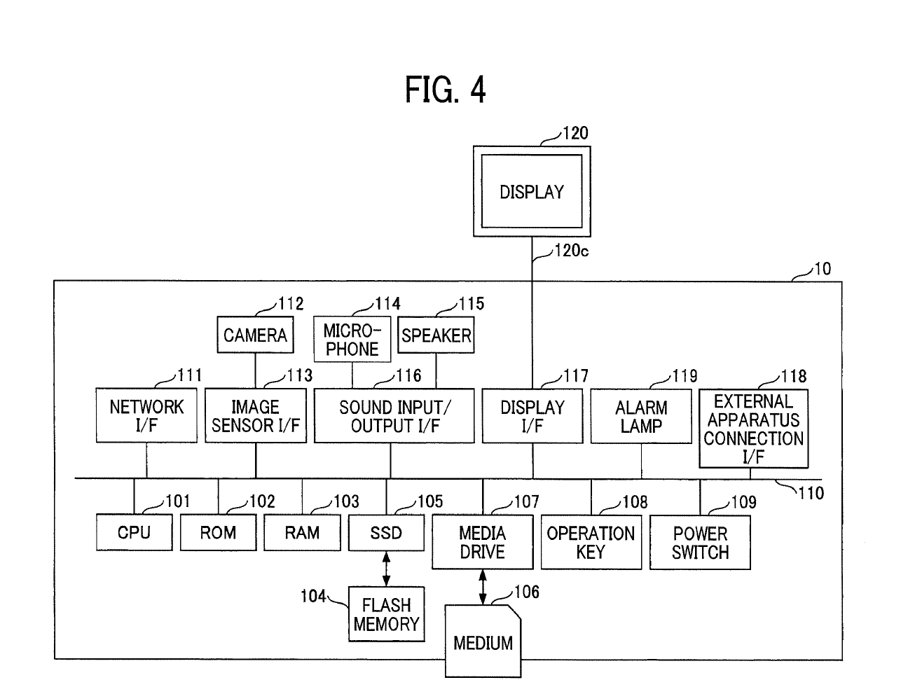

FIG. 4 illustrates an exemplary hardware configuration of the terminal 10 according to an embodiment. The terminal 10 has a typical computer configuration including, for example, a central processing unit (CPU) 101, a read only memory (ROM) 102, a random access memory (RAM) 103, a flash memory 104, and a solid state drive (SSD) 105. The terminal 10 further includes a media drive 107, the operation key(s) 108, the power switch 109, a network I/F 111, the camera 112, an image sensor I/F 113, the microphone 114, the speaker 115, and a sound input/output I/F 116. The terminal 10 further includes a display I/F 117, the external apparatus connection I/F 118, the alarm lamp 119, a bus 110, and the like.

The CPU 101 is, for example, a processor that reads programs and data from the ROM 102, the flash memory 104, and the like and performs processes to implement the functions of the terminal 10. The ROM 102 is, for example, a non-volatile memory that stores in advance programs and the like used to start the CPU 101, such as an initial program loader (IPL). The RAM 103 is a volatile memory used as a workarea and the like of the CPU 101.

The flash memory 104 is, for example, a storage device that stores an operating system (OS), an application program, various kinds of data, and the like. The SSD 105 controls reading and writing of various kinds of data from and to the flash memory 104 under control of the CPU 101. The media drive 107, for example, controls reading and writing (storing) of data from and to a recording medium 106 such as a memory card.

Each of the operation keys 108 is an input device that receives an input operation performed by a user of the terminal 10. The power switch 109 is a switch for switching on and off the power of the terminal 10. The network I/F 111 is a communication interface for communicating by using the communication network 2.

The camera 112 is an image capturing device for capturing images of a subject under control of the CPU 101. The image sensor I/F 113 controls image capturing performed by the camera 112 and converts data obtained through image capturing into predetermined image data (video data). The microphone 114 converts voice that has been collected into an electrical signal. The speaker 115 converts the voice signal into voice and outputs the voice. The sound input/output I/F 116 controls input and output of voice by using the microphone 114 and the speaker 115.

The display I/F 117 transmits image data to the display 120 under control of the CPU 101. The external apparatus connection I/F 118 is an interface for connecting a variety of external apparatuses. The alarm lamp 119 is a light emitting device for notifying a user in case of an abnormality in various functions of the terminal 10. The bus 110 is connected to each of the above components, and an address signal, a data signal, a variety of control signals, and the like are transmitted therethrough.

The display 120 is a display unit formed of a liquid crystal panel or an organic electroluminescent (EL) panel on which an image of a subject, an operation icon, and the like are displayed. In addition, the display 120 is connected to the display I/F 117 via the cable 120c.

The camera 112 includes a lens and a solid-state image sensor that converts light into electric charge to digitize an image (video) of a subject. Examples of the solid-state image sensor include a complementary metal oxide semiconductor (CMOS) sensor, a charge coupled device (CCD), and the like.

The external apparatus connection I/F 118 can be electrically connected to an external apparatus such as an external camera, an external microphone, or an external speaker via a Universal Serial Bus (USB) cable or the like inserted into the connection port 1132 of the housing 1100 illustrated in FIG. 3.

If an external camera is connected, the external camera is driven preferentially to the built-in camera 112 under control of the CPU 101. Likewise, if an external microphone is connected or an external speaker is connected, the external microphone or the external speaker is driven preferentially to the built-in microphone 114 or the built-in speaker 115, respectively, under control of the CPU 101.

The recording medium 106 is detachable from the terminal 10. Not only the flash memory 104, any non-volatile memory from or to which data is read or written under control of the CPU 101 may be used, such as an electrically erasable and programmable ROM (EEPROM).

The above-described terminal program may be recorded in a file in an installable format or an executable format on a computer-readable recording medium (e.g., the recording medium 106) to be circulated. In addition, the above-described terminal program may be stored in the ROM 102 instead of the flash memory 104.

Hardware Configuration of Management System

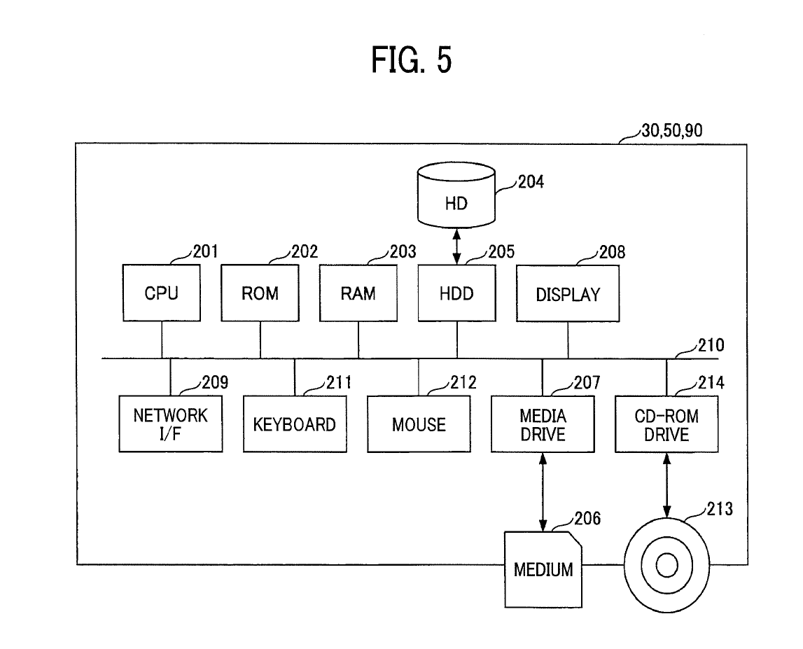

FIG. 5 illustrates a hardware configuration of the management system 50 according to an embodiment. The management system 50 has a typical computer hardware configuration including, for example, a CPU 201, a ROM 202, a RAM 203, an HD 204, a hard disk drive (HDD) 205, a media drive 207, a display 208, and the like. The management system 50 further includes a network I/F 209, a keyboard 211, a mouse 212, a compact disc (CD)-ROM drive 214, a bus 210, and the like.

The CPU 201 is, for example, a processor that reads programs and data from the ROM 202, the HD 204, and the like and performs processes to implement the functions of the management system 50. The ROM 202 is, for example, a non-volatile memory that stores in advance programs and the like used to start the CPU 201, such as an IPL. The RAM 203 is a volatile memory used as a workarea and the like of the CPU 201.

The HD 204 is, for example, a storage device that stores an OS, a program such as an application program, and various kinds of data. The HDD 205 controls reading and writing of various kinds of data from and to the 1-ID 204 under control of the CPU 201. The display 208 is a display device on which various kinds of information such as a cursor, a menu, a window, a character, and an image are displayed.

The network I/F 209 is a communication interface for performing data communication by using the communication network 2. The keyboard 211 is an exemplary input device for accepting an input operation of a character, a numeric value, various instructions, and the like performed by a user. The mouse 212 is an exemplary pointing device for accepting an operation for selecting and executing various instructions, selecting a process target, or moving a cursor, performed by a user.

The media drive 207 controls, for example, reading and writing (storing) of data from and to a recording medium 206 such as a memory card. The CD-ROM drive 214 controls reading and writing of data from and to a CD-ROM 213 of any kind as an exemplary detachable recording medium. The bus 210 electrically connects each of the above components, and an address signal, a data signal, a variety of control signals, and the like are transmitted therethrough.

Note that the above-described hardware configuration of the management system 50 is merely an example. For example, the display 208, the keyboard 211, the mouse 212, and the like may be externally connected to the management system 50.

The above-described program for the management system 50 may be recorded in a file in an installable format or an executable format on a computer-readable recording medium such as the recording medium 206 or the CD-ROM 213 to be circulated. In addition, the above-described program for the management system 50 may be stored in the HD 204 or may be stored in advance in the ROM 202.

The relay apparatus 30 has substantially the same hardware configuration as the above-described management system 50, and therefore description thereof will be omitted. Note that a program for the relay apparatus 30 for controlling the relay apparatus 30 is recorded on the HD 204. Also in this case, the program for the relay apparatus 30 may be recorded in a file in an installable format or an executable format on a computer-readable recording medium such as the recording medium 206 or the CD-ROM 213 to be circulated.

The program providing apparatus 90 also has substantially the same hardware configuration as the above-described management system 50, and therefore description thereof will be omitted. Note that a program for providing a program for controlling the program providing apparatus 90 is recorded on the HD 204. Also in this case, the program for providing a program may be recorded in a file in an installable format or an executable format on a computer-readable recording medium such as the recording medium 206 or the CD-ROM 213 to be circulated.

As another example of the detachable recording medium, a computer-readable recording medium such as a compact disc recordable (CD-R), a digital versatile disk (DVD), or a Blu-ray Disc may be used to record and provide a program.

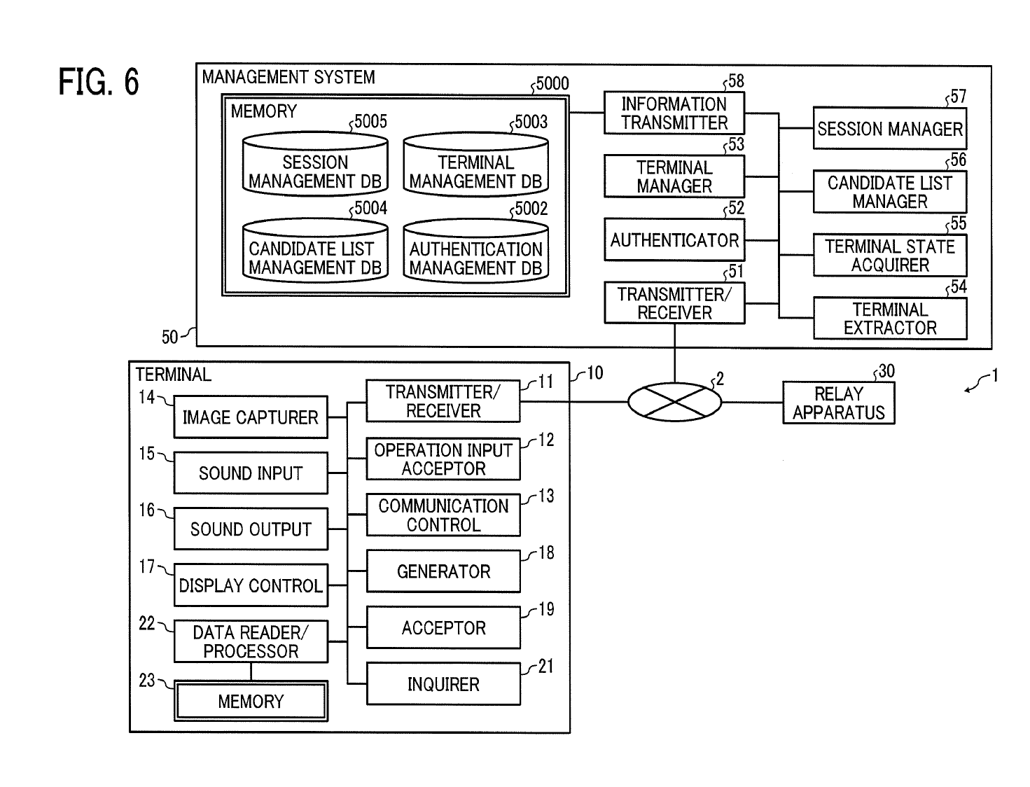

Functional Configurations FIG. 6 illustrates functional configurations of the terminal 10 and the management system 50 according to an embodiment. As illustrated in FIG. 6, the terminal 10, the relay apparatus 30, and the management system 50 are connected to one another via the communication network 2 so that communication can be performed. Note that the program providing apparatus 90 illustrated in FIG. 1 is omitted from FIG. 6 because it is not directly relevant to communication according to an embodiment.

Functional Configuration of Terminal

The terminal 10 includes a data transmitter/receiver 11, an operation input acceptor 12, a communication control 13, an image capturer 14, a sound input 15, a sound output 16, a display control 17, a generator 18, an acceptor 19, an inquirer 21, a data reader/processor 22, and the like. Each of the above functions is implemented by a terminal control program that is loaded from the flash memory 104 to the RAM 103 and executed by the CPU 101, for example. In addition, the terminal 10 further includes a memory 24 configured by the RAM 103, the flash memory 104, and the like.

The data transmitter/receiver 11 is implemented by, for example, a program executed by the CPU 101 illustrated in FIG. 4, the network OF 111 illustrated in FIG. 4, and the like and transmits and receives various kinds of data, information, and the like to and from another terminal 10, an apparatus, or a system via the communication network 2. For example, the data transmitter/receiver 11 serves as a receiver that receives from the management system 50, terminal information (e.g., a candidate identifier or a terminal name) for designating another terminal 10 as a candidate communication counterpart of the terminal 10 (hereinafter the other terminal 10 as a candidate communication counterpart will be referred to as a candidate terminal) and state information indicating the operating state of the candidate terminal.

In addition, before starting a videoconference with a counterpart terminal, the data transmitter/receiver 11 according to an embodiment starts to receive from the management system 50, state information indicating the state of each terminal 10 as a candidate connection destination for a videoconference. The state information indicates not only the operating state of each terminal 10 as to whether the terminal 10 is online or offline but also the operating state as to whether the terminal 10 is online and capable of communicating or is online and currently communicating, or the like.

The operation input acceptor 12 is implemented by, for example, a program executed by the CPU 101 illustrated in FIG. 4, the operation key(s) 108 and the power switch 109 illustrated in FIG. 4, and the like and accepts various input operations performed by a user. For example, if a user switches on the power switch 109 illustrated in FIG. 4, the operation input acceptor 12 illustrated in FIG. 6 accepts the power on operation, and the power is controlled to be switched on. In addition, the operation input acceptor 12 accepts a calling operation and the like performed by a user through, for example, depressing or the like of the operation key(s) 108.

The communication control 13 is implemented by, for example, a program executed by the CPU 101 illustrated in FIG. 4. For example, in response to acceptance of the above power on operation, the communication control 13 automatically transmits login request information for requesting login and the current IP address of the request sender terminal from the data transmitter/receiver 11 to the management system 50 via the communication network 2. In addition, if a user switches off the power switch 109 from the state in which the power was on, the data transmitter/receiver 11 transmits to the management system 50, state information for switching off the power, and then the operation input acceptor 12 switches off the power. Thus, the management system 50 can acquire the information that the terminal 10 has been switched off from the state in which the power was on.

In addition, the communication control 13 controls communication in various manners, such as establishing and ending a communication session in which content data is transmitted and received to and from another terminal 10 through the relay apparatus 30.

The image capturer 14 is implemented by, for example, a program executed by the CPU 101 illustrated in FIG. 4, the camera 112 and the image sensor I/F 113 illustrated in FIG. 4, and the like and captures an image of a subject and outputs image data obtained by capturing the image.

The sound input 15 is implemented by, for example, a program executed by the CPU 101 illustrated in FIG. 4, the sound input/output I/F 116 illustrated in FIG. 4, and the like and inputs sound data related to a voice signal that has been obtained by conversion of a voice of a user performed by the microphone 114.

The sound output 16 is implemented by, for example, a program executed by the CPU 101 illustrated in FIG. 4, the sound input/output I/F 116 illustrated in FIG. 4, and the like and outputs a voice signal related to sound data to the speaker 115 to output the sound from the speaker 115.

The display control 17 is implemented by, for example, a program executed by the CPU 101 illustrated in FIG. 4, the display I/F 117 illustrated in FIG. 4, and the like and causes image data to be displayed on the display 120. For example, the display control 17 causes a candidate list that is a list of candidate terminals, which are candidate communication counterparts of the terminal 10, to be displayed on a display unit such as the display 120 in such a manner that any one of the candidate terminals can be selected.

The candidate list preferably includes terminal information (e.g., identifiers and terminal names) for designating the candidate terminals, state information indicating the operating states of the candidate terminals, and the like.

The generator 18 is implemented by, for example, a program executed by the CPU 101 illustrated in FIG. 4 and generates the candidate list that is a list of candidate terminals including terminal information and state information of the candidate terminals received by the data transmitter/receiver 11.

The acceptor 19 is implemented by, for example, a program executed by the CPU 101 illustrated in FIG. 4 and accepts an operation of starting communication (input operation of an identifier) using the terminal information of a counterpart terminal (e.g., an identifier for identifying a counterpart terminal) serving as a communication counterpart (request destination).

If the candidate list generated by the generator 18 includes the terminal information of a counterpart terminal accepted by the acceptor 19, on the basis of the state information of the counterpart terminal, the data transmitter/receiver 11 serves as a transmitter that transmits to the management system 50, request information (e.g., start request information) for requesting the management system 50 to start communication.

Examples of the operating state of the terminal 10 include “online (communicating)”, “online (capable of communicating)”, “offline”, and the like. The operating state “online (capable of communicating)” represents a state in which the terminal 10 has logged in to the management system 50 and is not communicating (e.g., not performing a videoconference or the like). The operating state “online (communicating)” represents a state in which the terminal 10 has logged in to the management system 50 and is currently communicating. The operating state “offline” represents a state in which the terminal 10 is incapable of communicating (e.g., the terminal 10 has not logged in to the management system 50).

For example, if the state of a candidate terminal corresponding to the terminal information of the counterpart terminal is “online (capable of communicating)” (hereinafter simply represented as “capable of communicating”), the data transmitter/receiver 11 transmits to the management system 50, start request information for requesting the start of communication with the candidate terminal corresponding to the terminal information of the counterpart terminal.

For example, if the state of the candidate terminal corresponding to the terminal information of the counterpart terminal is “online (communicating)” (hereinafter simply represented as “communicating”), the data transmitter/receiver 11 transmits to the management system 50, participation request information for requesting participation in communication (communication session) that is currently performed by the candidate terminal.

For example, if the state of the candidate terminal corresponding to the terminal information of the counterpart terminal is “offline”, the data transmitter/receiver 11, for example, suspends transmission of any request information to the management system 50.

The inquirer 21 is implemented by a program executed by the CPU 101 illustrated in FIG. 4. For example, if the candidate list generated by the generator 18 does not include the candidate terminal corresponding to the terminal information of the counterpart terminal accepted by the acceptor 19, the inquirer 21 makes an inquiry to the management system 50 about whether the accepted terminal information is terminal information available in the management system 50. Note that the terminal information available in the management system 50 is, for example, information about a terminal that is permitted to communicate and that has been registered in the management system 50.

The data reader/processor 22 is implemented by a program executed by the CPU 101 illustrated in FIG. 4, the SSD 105 illustrated in FIG. 4, and the like and performs processing of causing various kinds of data to be stored in the memory 23 and reading the various kinds of data from the memory 24.

The memory 23 is implemented by, for example, the flash memory 104 and the RAM 103 illustrated in FIG. 4, a program executed by the CPU 101 illustrated in FIG. 4, and the like and stores, for example, information such as an identifier for identifying the terminal 10 and a password.

In addition, the memory 23 is also used as, for example, a reception buffer of image data and sound data received when performing a videoconference with the counterpart terminal.

Functional Configuration of Management System

The management system 50 includes a data transmitter/receiver 51, an authenticator 52, a terminal manager 53, a terminal extractor 54, a terminal state acquirer 55, a candidate list manager 56, a session manager 57, a data reader/processor 58, and the like. Each of the above functions is implemented in accordance with a communication-management program that is loaded from the HD 204 to the RAM 203 and executed by the CPU 201. In addition, the management system 50 further includes a memory 5000 configured by the HD 204 and the like.

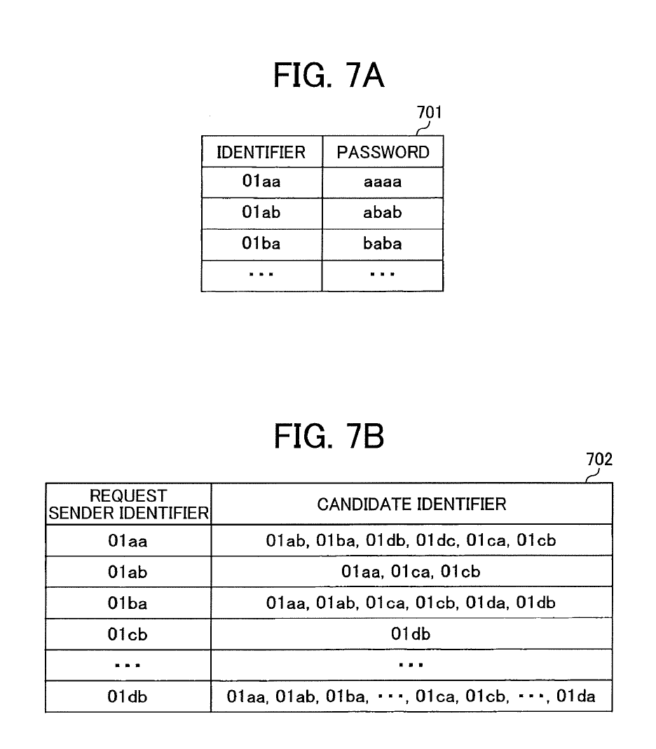

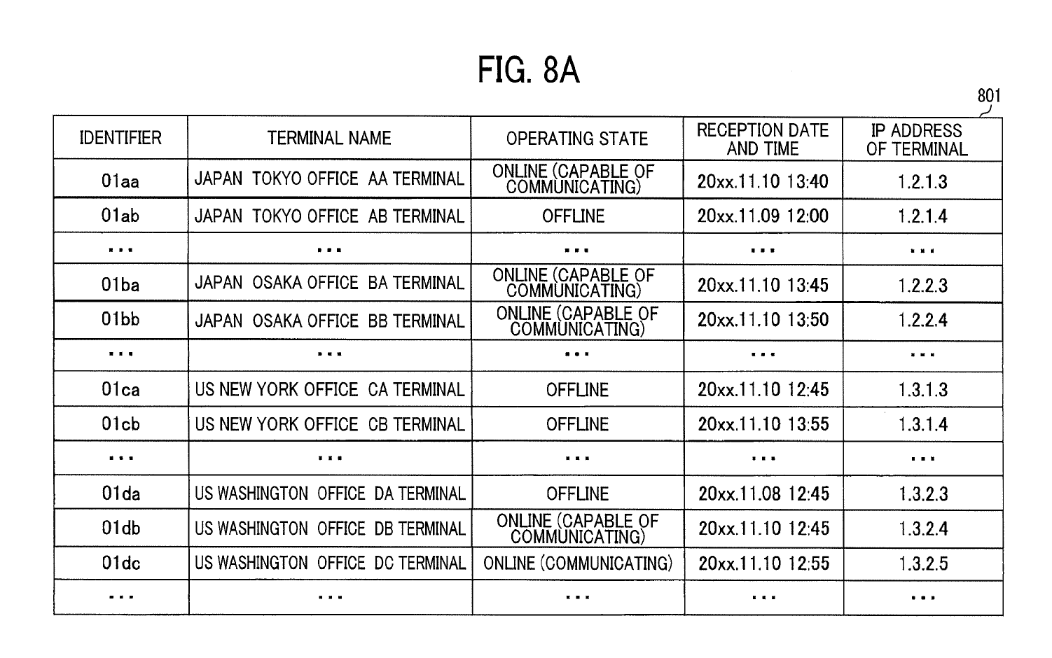

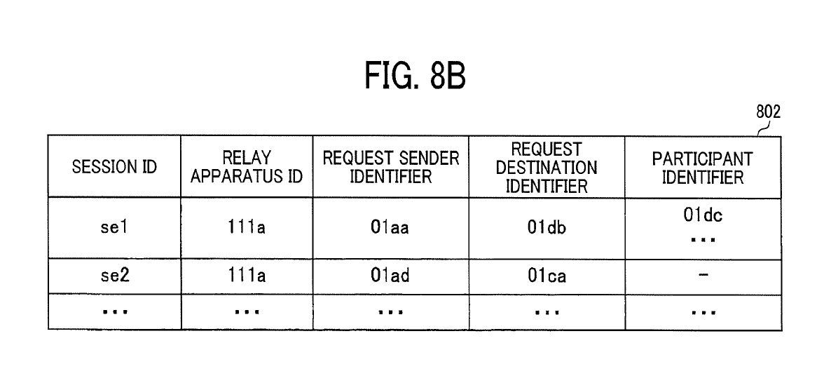

Now, information stored in the memory 5000 and managed by the management system 50 will be described. FIGS. 7A to 8B illustrate exemplary information managed by the management system 50 according to an embodiment.

Authentication Management Table

FIG. 7A illustrates an exemplary authentication management table. In the memory 5000, for example, an authentication management database (DB) 5002 including an authentication management table 701 illustrated in FIG. 7A is configured. In the authentication management table 701, identifiers for identifying the respective terminals 10 managed by the management system 50 are managed in association with the respective passwords. For example, the authentication management table 701 illustrated in FIG. 7A indicates that the password corresponding to an identifier “01aa” is “aaaa”.

Candidate List Management Table

FIG. 7B illustrates an exemplary candidate list management table. In the memory 5000, for example, a candidate list management DB 5004 including a candidate list management table 702 illustrated in FIG. 7B is configured. In the candidate list management table 702, request sender identifiers that are the identifiers of request sender terminals are managed in association with candidate identifiers that are the identifiers of candidate counterpart terminals. Here, a request sender terminal is a terminal 10 serving as a sender of request information for requesting the start of communication for a videoconference. In addition, a candidate counterpart terminal is a terminal 10 that can be set as the destination to which the request sender terminal can transmit the request information and that has been registered as a candidate counterpart.

Note that the identifiers include terminal identifiers (IDs) for identifying the terminals, user IDs for identifying users, and the like.

That is, any one of the IDs described above is an example of identification information identifying the device or terminal, or the user operating the device or terminal. In alternative to the device ID or terminal ID for identifying a specific device, a manufacturing number may be used as identification information for identifying the device or terminal. In alternative to the user name identifying a specific user, any user name capable of identifying the user such as a user's nickname may be registered.

For example, the example illustrated in FIG. 7B indicates that candidate counterpart terminals to which the terminal 10 whose identifier is “01aa” can request the start of a videoconference are terminals 10 whose identifiers are “01ab”, “01ba”, “01db”, “01dc”, “01ca”, and “01cb”. A candidate counterpart terminal is, for example, added or deleted in accordance with a request from the terminal 10 to the management system 50.

Terminal Management Table

FIG. 8A illustrates an exemplary terminal management table. In the memory 5000, for example, a terminal management DB 5003 including a terminal management table 801 illustrated in FIG. 8A is configured.

In the terminal management table 801, the names of the terminals 10 (hereinafter referred to as “terminal names”), the operating states of the terminals 10, the reception date and time, and the IP addresses of the terminals 10 are managed in association with one another according to the identifier of each terminal 10. The reception date and time represents the date and time at which the management system 50 received login request information for logging in to the communication system 1.

For example, the terminal management table 801 illustrated in FIG. 8A indicates that a terminal 10 whose identifier is “01aa” has a terminal name “Japan, Tokyo Office, Terminal AA” and the operating state “online (communicating)”. In addition, the terminal management table 801 also indicates that the date and time at which the management system 50 received login request information is “20xx, November 10, 13:40” and that the IP address of the terminal 10 is “1.2.1.3”.

Here, the identifier in the terminal management table 801 is uniquely assigned when a terminal 10 is registered in the communication system 1, and the terminal name is registered or changed by an administrator of the management system 50. Note that the terminal name may be registered or changed in accordance with a request from a terminal 10 to the management system 50.

Session Management Table

A session management DB 5005 stored in the memory 5000 of the management system 50 includes, for example, a session management table 802 illustrated in FIG. 8B. In the session management table 802, information is stored, such as a relay apparatus ID that is an identifier for identifying the relay apparatus 30, request sender identifiers, counterpart identifiers, and participant identifiers according to the session ID that is the identifier of a communication session.

Note that the request sender identifiers are the identifiers of request sender terminals that request the start of a communication session for a videoconference or the like, the counterpart identifiers are the identifiers of counterpart terminals that are requested to start the videoconference. The participant identifiers are the identifiers of one or more participation request terminals that request participation in a communication session (established session) for, for example, an active videoconference.

For example, the session management table 802 illustrated in FIG. 8B indicates that a terminal whose identifier is “01aa”, a terminal whose identifier is “01db”, and a terminal whose identifier is “01dc” are participating in a session whose session ID is “se1”.

Referring back to FIG. 6, the functional configuration of the management system 50 will be further described.

The data transmitter/receiver 51 is implemented by, for example, the network I/F 209 illustrated in FIG. 5, a program executed by the CPU 201 illustrated in FIG. 5, and the like and transmits and receives various kinds of data and information to and from another terminal 10 or an apparatus via the communication network 2.

The data transmitter/receiver 51 transmits to the terminal 10, the terminal information of a candidate terminal(s), which is a candidate communication counterpart terminal of the terminal 10, and the state information representing the operating state(s) and the like of the candidate terminal(s). Each time the operating state of a candidate terminal is changed, the data transmitter/receiver 51 transmits the latest state information to the terminal 10.

The authenticator 52 is implemented by, for example, a program executed by the CPU 201 illustrated in FIG. 5. The authenticator 52 searches the authentication management table 701 included in the authentication management DB 5002 in the memory 5000 by using, as a search key, an identifier and a password included in the login request information received through the data transmitter/receiver 51. In addition, the authenticator 52 determines whether the identifier and the password included in the login request information are managed in the authentication management DB 5002 to authenticate the terminal 10.

The terminal manager 53 is implemented by, for example, a program executed by the CPU 201 illustrated in FIG. 5. The terminal manager 53 manages the operating state of the terminal 10 that has logged in to the management system 50. The terminal manager 53 stores and manages, for example, the operating state, the reception date and time at which the management system 50 received the login request information, and the IP address in the terminal management table 801 included in the terminal management DB 5003 in association with the identifier of a request sender terminal. For example, if a user switches off the power switch 109 of the terminal 10 from the state in which the power was on, on the basis of the state information for switching off the power transmitted from the terminal 10, the terminal manager 53 changes the operating state of the terminal 10 in the terminal management table 801 from online to offline.

The terminal extractor 54 is implemented by, for example, a program executed by the CPU 201 illustrated in FIG. 5. The terminal extractor 54 searches the candidate list management table 702 included in the candidate list management DB 5004 by using, as a search key, the identifier of the request sender terminal that has requested login, and extracts the identifiers of candidate counterpart terminals of the request sender terminal.

The terminal extractor 54 also searches the candidate list management table 702 by using, as a search key, the identifier of the request sender terminal that has requested login, and extracts the identifier of a different request sender terminal for which the request sender terminal has been registered as a candidate counterpart terminal.

The terminal state acquirer 55 is implemented by, for example, a program executed by the CPU 201 illustrated in FIG. 5. The terminal state acquirer 55 searches the terminal management table 801 included in the terminal management DB 5003 by using, as search keys, the identifiers of the candidate counterpart terminals extracted by the terminal extractor 54 and reads the operating state for each of the extracted identifiers.

Thus, the terminal state acquirer 55 can acquire the operating states of the candidate counterpart terminals of the request sender terminal that has requested login. In addition, the terminal state acquirer 55 searches the terminal management DB 5003 by using the identifiers extracted by the terminal extractor 54 as search keys and acquires the operating state of the request sender terminal that has requested login.

The candidate list manager 56 is implemented by, for example, a program executed by the CPU 201 illustrated in FIG. 5 and manages, for example, the candidate list management table 702 illustrated in FIG. 7B stored in the candidate list management DB 5004. For example, the candidate list manager 56 registers a candidate identifier in accordance with a request for registration in the candidate list management table 702, the request having been received from the terminal 10. In addition, the candidate list manager 56 deletes a candidate identifier in accordance with a request for deletion from the candidate list management table 702, the request having been received from the terminal 10.

The session manager 57 is implemented by, for example, a program executed by the CPU 201 illustrated in FIG. 5 and manages communication (communication session) for transmitting and receiving content data between the plurality of terminals 10 in the communication system 1. For example, the session manager 57 generates a session ID that is an identifier for identifying a communication session at the time of starting the communication session. In addition, the session manager 57 stores and manages information in the session management table 802 included in the session management DB 5005, such as the identifier of a terminal 10 that participates in the communication session and the relay apparatus ID of the relay apparatus 30, in association with the generated session ID.

The data reader/processor 58 is implemented by, for example, a program executed by the HDD 205 illustrated in FIG. 5 and the CPU 201 illustrated in FIG. 5, and the like and, for example, causes various kinds of data to be stored in the memory 5000 and reads the various kinds of data from the memory 5000.

Relay Apparatus

The relay apparatus 30 relays transmission and reception of content data between a plurality of terminals 10 in a videoconference performed between the terminals 10. For example, on the basis of the session ID that is transmitted from the management system 50, the relay apparatus 30 causes a terminal 10 having the same session ID to participate in the same session. Thus, terminals 10 having the same session ID can transmit and receive content data through the relay apparatus 30.

Operation of Communication System

Next, operation performed by the communication system 1 will be described.

Preparatory Process

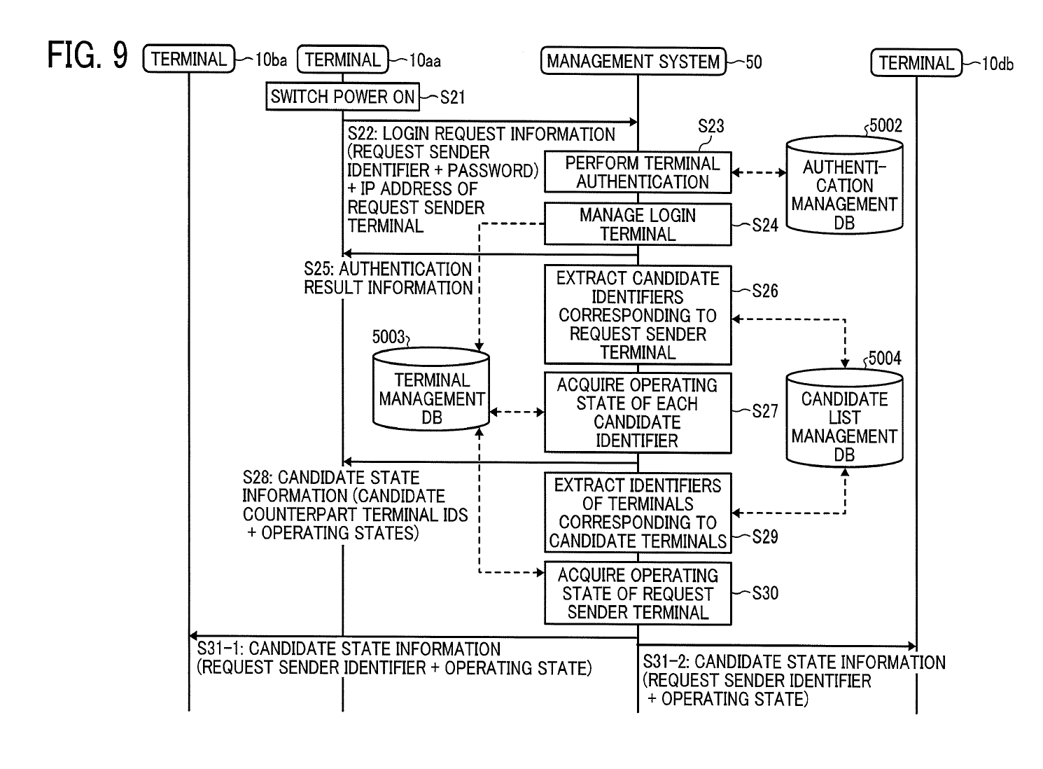

FIG. 9 illustrates a sequence of an exemplary preparatory process according to an embodiment. This process represents an exemplary preparatory process in which a preparatory state is set for the terminal 10aa to be capable of participating in a videoconference in the communication system 1.

Note that, in FIG. 9, information is transmitted and received by using the management-data session sei illustrated in FIG. 2, for example. In addition, the following description will be given by assuming that, in FIG. 9, the identifier of the terminal 10aa is “01aa”, the identifier of the terminal 10ba is “01ba”, and the identifier of the terminal 10db is “01db”.

In step S21, a user of the terminal 10aa switches on the power switch 109 of the terminal 10aa, and upon the power on operation being accepted, the operation input acceptor 12 controls the power of the terminal 10aa to be switched on.

In step S22, in response to acceptance of the power on operation, the communication control 13 transmits login request information for requesting login from the data transmitter/receiver 11 of the terminal 10aa to the management system 50 via the communication network 2. The login request information includes a request sender identifier for identifying the terminal 10aa that requests login and a password. The request sender identifier and the password are read from the memory 23 through the data reader/processor 22.

Note that, if the management system 50 receives the login request information transmitted from the terminal 10aa, the management system 50 can acquire the IP address of the terminal 10aa that has transmitted the login request information.

In step S23, the authenticator 52 of the management system 50 performs terminal authentication by using, as search keys, the identifier and the password included in the login request information received through the data transmitter/receiver 51. The authenticator 52 searches the authentication management table 701 included in the authentication management DB 5002 in the memory 5000 and determines whether the same identifier and password as the search keys are managed in the authentication management DB 5002 to perform terminal authentication.

Now, a case will be described in which the authenticator 52 determines that the same identifier and password as the search keys are not managed, that is, the authenticator 52 determines that the login request is not from a terminal 10 having a legitimate use authority. In this case, the data transmitter/receiver 51 transmits authentication result information representing the authentication result obtained by the authenticator 52 to the terminal 10aa, which has requested login, via the communication network 2, and the preparatory process ends.

On the other hand, a case will be described in which the authenticator 52 determines that the same identifier and password as the search keys are managed, that is, the authenticator 52 determines that the login request is from a terminal 10 having a legitimate use authority. In this case, in step S24, the terminal manager 53 stores the identifier, the IP address, and the operating state of the terminal 10aa, the reception date and time, and the like in association with one another in the terminal management table 801 included in the terminal management DB 5003.

Thus, it is possible to manage the identifier “01aa”, the IP address of the terminal 10aa “1.2.1.3”, the operating state “online (communicating)”, the reception date and time “20xx.11.10 13:40 (year/month/day, time)” in association with one another in the terminal management table 801. Note that, the identifier, the IP address, and the like may be associated with one another in advance in the terminal management table 801, and the operating state, the reception date and time, and a participant may be associated with one another as necessary.

In step S25, the data transmitter/receiver 51 of the management system 50 transmits the authentication result information representing the authentication result obtained by the authenticator 52 to the terminal 10aa, which has requested login, via the communication network 2.

In step S26, the terminal extractor 54 of the management system 50 searches the candidate list management table 702 included in the candidate list management DB 5004 by using the identifier “01aa” of the terminal 10aa as a search key and extracts the identifiers of candidate counterpart terminals of the terminal 10aa.

In this example, the identifiers “01ab”, “01ba, “01db”, “01dc”, “01ca”, and “01cb” of the terminals 10ab, 10ba, 10db, 10dc, 10ca, and 10cb, respectively, serving as the candidate counterpart terminals of the terminal 10aa whose identifier is “01aa” are extracted.

In step S27, the terminal state acquirer 55 of the management system 50 sets the identifiers “01ab”, “01ba, “01db”, “01dc”, “01ca”, and “01cb” of the candidate counterpart terminals extracted by the terminal extractor 54 as search keys. By using the search keys, the terminal state acquirer 55 searches the terminal management table 801 included in the terminal management DB 5003 and reads operating states “offline”, “online (capable of communicating)”, and “online (communicating)” for each identifier extracted by the terminal extractor 54. Thus, the operating states of the terminals 10ab, 10ba, 10db, 10dc, 10ca, and 10cb can be acquired. Note that the terminal state acquirer 55 monitors the terminal management DB 5003 and acquires the operating state each time the operating state of a terminal is changed.

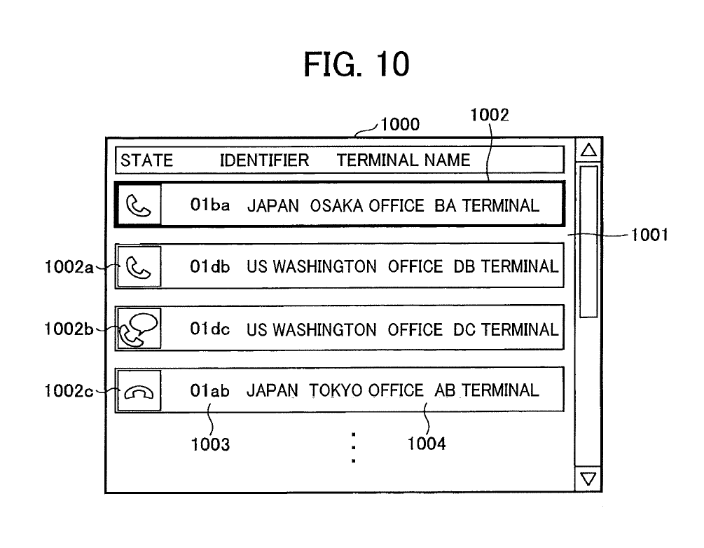

In step S28, the data transmitter/receiver 51 of the management system 50 transmits the state information of the candidate counterpart terminals to the terminal 10aa via the communication network 2. The state information of the candidate counterpart terminals includes, for example, the identifiers “01ab”, “01ba, “01db”, “01dc”, “01ca”, and “01cb” used as search keys in step S27, the state information representing the operating state of each of the terminals 10, and the like. For example, in addition to the identifiers of the candidate counterpart terminals, the state information may further include the terminal names of the candidate counterpart terminals, which may be displayed on the candidate list of FIG. 10. Thus, the terminal 10aa can acquire the current operating states “offline”, “online (capable of communicating)”, and “online (communicating)” of the terminals 10ab, 10ba, 10db, 10dc, 10ca, and 10cb, which are candidate counterpart terminals.

In step S29, the terminal extractor 54 of the management system 50 sets the identifier “01aa” of the terminal 10aa, which has requested login, as a search key. By using the search key, the terminal extractor 54 searches the candidate list management table 702 included in the candidate list management DB 5004 and extracts the identifiers of other terminals for which the identifier “01aa” of the terminal 10aa has been registered as a candidate counterpart terminal. For example, in the candidate list management table 702 illustrated in FIG. 7B, the extracted identifiers are “01ab”, “01ba”, and “01db”.

In step S30, the terminal manager 53 of the management system 50 sets the identifier “01aa” of the terminal 10aa, which has requested login, as a search key. By using the search key, the terminal manager 53 searches the terminal management table 801 included in the terminal management DB 5003 and acquires the operating state “online (capable of communicating)” of the terminal 10aa, which has requested login.

In steps S31-1 and S31-2, the data transmitter/receiver 51 of the management system 50 extracts, from among the identifiers extracted in step S29, for example, the identifier(s) of terminal(s) 10 whose operating state is online according to the terminal management table 801 illustrated in FIG. 8A. In addition, the data transmitter/receiver 51 transmits the state information including the identifier of the request sender terminal (the terminal 10aa) and an operating state “online (capable of communicating)” to the terminal(s) 10 (e.g., the terminal 10ba and the terminal 10db) corresponding to the designated identifier(s).

Note that, when transmitting the state information to the terminals 10ba and 10db, based on the identifiers “01ba” and “01db”, the data transmitter/receiver 51 refers to the IP address of each of the terminals 10 managed in the terminal management table 801. Thus, the identifier “01aa” and the operating state “online (capable of communicating)” of the terminal 10aa, which has requested login, can be transmitted to the terminals 10db and 10ba that can designate the terminal 10aa, which has requested login, as a counterpart terminal and can communicate with the terminal 10aa.

Through the above process, the generator 18 of the terminal 10 acquires information (e.g., the identifiers, the terminal names, and the operating states) of candidate terminals that is necessary to generate a candidate list, the state information representing the operating states of the candidate terminals, and the like and generates a candidate list by using the acquired information.

Upon the candidate list being generated, the display control 17 of the terminal 10 causes the generated candidate list to be displayed on a display unit (e.g., the display 120) of the terminal 10. An exemplary candidate list displayed on the display unit at this time is illustrated in FIG. 10.

FIG. 10 illustrates an exemplary candidate list according to an embodiment. In the example illustrated in FIG. 10, in a candidate list 1001 displayed on a display unit 1000, a plurality of selection keys 1002 for selecting a counterpart terminal as a communication counterpart are displayed. The selection keys 1002 include icons 1002a to 1002c that reflect the state information, identifiers 1003 and terminal names 1004 of the counterpart terminals, and the like. Note that the identifier 1003 and the terminal name 1004 of each counterpart terminal is exemplary terminal information of the counterpart terminal.

The icons are, for example, the icon 1002a representing a state of being capable of communicating, the icon 1002b representing a state of currently communicating, the icon 1002c representing a state of being offline and incapable of communicating, and the like. If the operating state of a counterpart terminal is “online (capable of communicating)”, the generator 18 assigns the icon 1002a to the counterpart terminal. If the operating state of a counterpart terminal is “online (communicating)”, the generator 18 assigns the icon 1002b to the counterpart terminal. If the operating state of a counterpart terminal is “offline”, the generator 18 assigns the icon 1002c to the counterpart terminal.

In addition, in the candidate list 1001 illustrated in FIG. 10, for example, the selection key 1002 of the terminal 10ba whose identifier is “01ba” displayed on top receives focus, and the selection key 1002 of the terminal 10ba is displayed in a bold frame (exemplary display component).

Note that the focus represents a state in which, for example, a display component or the like is selectable on an operation screen of a computer or the like. In an embodiment, “receiving focus” means, for example, displaying a candidate identifier of a terminal 10 selected as a communication counterpart from the candidate list 1001 displayed by the display control 17 to be distinguishable by using a display component such as a bold frame or a cursor, or highlighting. Thus, upon acceptance of a user's calling operation for an instruction to start communication, the terminal 10 starts a process for calling the counterpart that receives focus in the candidate list. Note that the focus is an exemplary method for displaying a candidate identifier in a distinguishable manner in the candidate list, indicating that a terminal is selected as a communication counterpart. The method for displaying a selected candidate identifier in a distinguishable manner is not limited to the focus and may be color changing, bolding, blinking, or the like so as to display the selected candidate identifier to be distinguishable from the other identifiers.

In addition, displaying in a distinguishable (emphasized) manner means displaying the accepted identifier in such a manner that it is understood that the identifier is included in the list. Thus, for example, the identifier itself may be displayed to be distinguishable, or a message such as “included in list” may be displayed to be distinguishable.

Communication Process

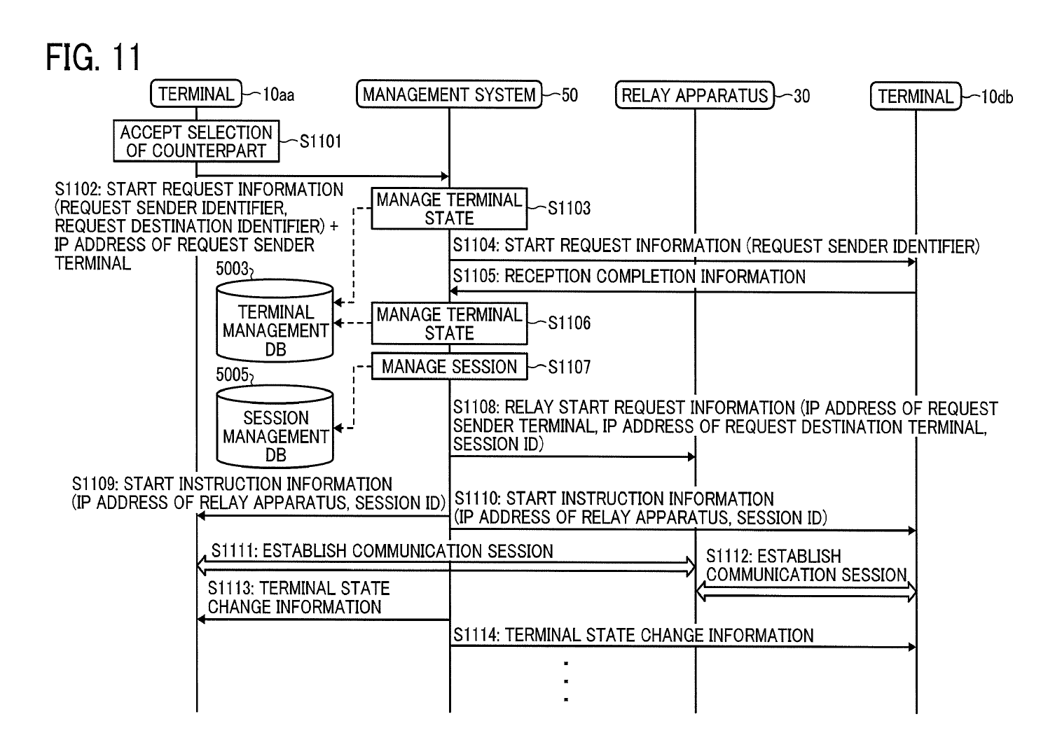

FIG. 11 illustrates a sequence of an exemplary communication process according to an embodiment. This exemplary process illustrates a case in which the terminal 10aa calls the terminal 10db by using a candidate list to start communication of content data. Note that in FIG. 11, various kinds of management data are transmitted and received between each of the terminals 10 and the management system 50 in the management-data session sei illustrated in FIG. 2.

In step S1101, the operation input acceptor 12 of the terminal 10aa accepts a selection operation for a counterpart terminal (the terminal 10db) performed by a user. For example, the operation input acceptor 12 of the terminal 10aa accepts a user's selection of a selection key corresponding to the terminal 10db whose identifier is “01db” from the candidate list 1001 illustrated in FIG. 10.

In step S1102, in response to the selection operation for the counterpart terminal accepted by the operation input acceptor 12, the communication control 13 of the terminal 10aa transmits to the management system 50, start request information for requesting the start of a communication session. The start request information includes, for example, a request sender identifier that is the identifier of the terminal 10aa serving as a request sender terminal, a candidate identifier that is the identifier of the terminal 10db serving as a counterpart terminal, and the like. The start request information further includes the IP address of the terminal 10aa (the IP address of the request sender).

In step S1103, upon the start request information being received from the terminal 10aa, the terminal manager 53 of the management system 50 updates the terminal management table 801 included in the terminal management DB 5003, based on the request sender identifier included in the start request information. For example, the terminal manager 53 changes the information about the operating state corresponding to the identifier “01aa” of the terminal 10aa to “online (communicating)”, and updates information about the reception date and time.

In step S1104, the session manager 57 of the management system 50 transmits to the terminal 10db serving as the counterpart terminal, the start request information for requesting the start of a session. The start request information includes, for example, the request sender identifier of the terminal 10aa serving as the request sender terminal, and the like. In step S1105, upon the start request information being received from the management system 50, for example, the terminal 10db transmits reception completion information to the management system 50 in accordance with a responding operation or the like performed by a user of the terminal 10db. The reception completion information includes, for example, a candidate identifier that is the identifier of the terminal 10db. Note that the reception completion information may be automatically transmitted form the terminal 10db, for example.

In step S1106, upon the reception completion information being received from the terminal 10db, the terminal manager 53 of the management system 50 updates the terminal management table 801 included in the terminal management DB 5003, on the basis of the identifier of the terminal 10db included in the reception completion information. For example, the terminal manager 53 changes information about the operating state corresponding to the identifier “01 db” of the terminal 10db to “online (communicating)” and updates information about the reception date and time.

In step S1107, the session manager 57 of the management system 50 generates a session ID that is an identifier for identifying a communication session. In addition, the session manager 57 stores the relay apparatus ID of the relay apparatus 30, the request sender identifier, and the request destination identifier (counterpart identifier) in association with the generated session ID in the session management table 802 included in the session management DB 5005.

In step S1108, the session manager 57 of the management system 50 transmits to the relay apparatus 30, relay start request information for requesting the start of a communication session relay. The relay start request information includes, for example, the session ID generated in step S1107, the IP address of the request sender terminal, the IP address of the counterpart terminal, and the like.

In steps S1109 and S1110, the session manager 57 of the management system 50 transmits to the terminals 10aa and 10db, start instruction information as an instruction for starting a session. The start instruction information includes, for example, the session ID generated in step S1107, the IP address of the relay apparatus 30, and the like.

In step S1111, the communication control 13 of the terminal 10aa establishes a communication session (session sed) with the relay apparatus 30 by using the start instruction information received from the management system 50.

In step S1112, the communication control 13 of the terminal 10db establishes a communication session (session sed) with the relay apparatus 30 by using the start instruction information received from the management system 50.

Through the above process, the terminals 10aa and 10db can participate in the same communication session and can transmit content data to each other through the relay apparatus 30, thereby, for example, enabling a videoconference or the like.

In steps S1113 and S1114, the terminal manager 53 of the management system 50 transmits to each of the terminals 10 that are registered in the terminal management DB 5003, terminal state change information that is a notification of a change in the states of the terminals 10. In the example in FIG. 10, the terminal state change information includes the identifiers of the terminals 10aa and 10db whose terminal states have been changed, the state information indicating the operating states of the terminals 10aa and 10db, and the like. Note that the state information may include the session ID of the session in which each of the terminals 10 is participating, and the like.

### First Embodiment

Next, operation of controlling communication according to a first embodiment will be described. In the communication process illustrated in FIG. 11, description has been made on the assumption that a user, for example, selects a counterpart terminal serving as a communication counterpart form the candidate list 1001 illustrated in FIG. 10 and calls the counterpart terminal.

However, for example, if the number of counterpart terminals registered in the candidate list 1001 is increased, a user takes a longer time to select from the candidate list 1001, a counterpart terminal with which the user wishes to communicate. In addition, if a user does not know whether the counterpart terminal with which the user wishes to communicate has been registered in the candidate list 1001, just to determine whether the counterpart terminal has been registered in the candidate list 1001 takes a longer time.

Accordingly, in the terminal 10 according to this embodiment, it is possible to perform a communication start operation (calling operation) for a counterpart terminal registered in the candidate list 1001 by using the terminal information (e.g., the identifier) of the counterpart terminal serving as the communication counterpart.

Thus, in the communication system 1 in which communication with a terminal 10 serving as the communication counterpart is started by using a candidate list, the terminal 10 according to this embodiment can reduce the time taken to call a terminal 10 registered in the candidate list.

Terminal Calling Process

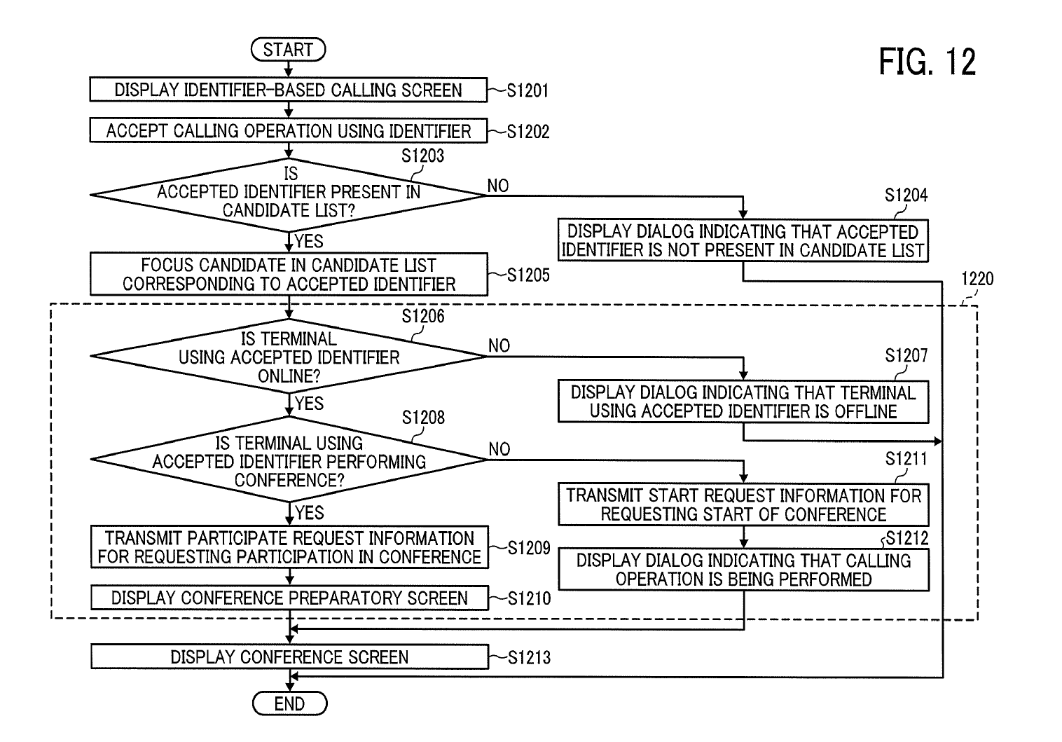

FIG. 12 is a flowchart of an exemplary terminal calling process according to the first embodiment.

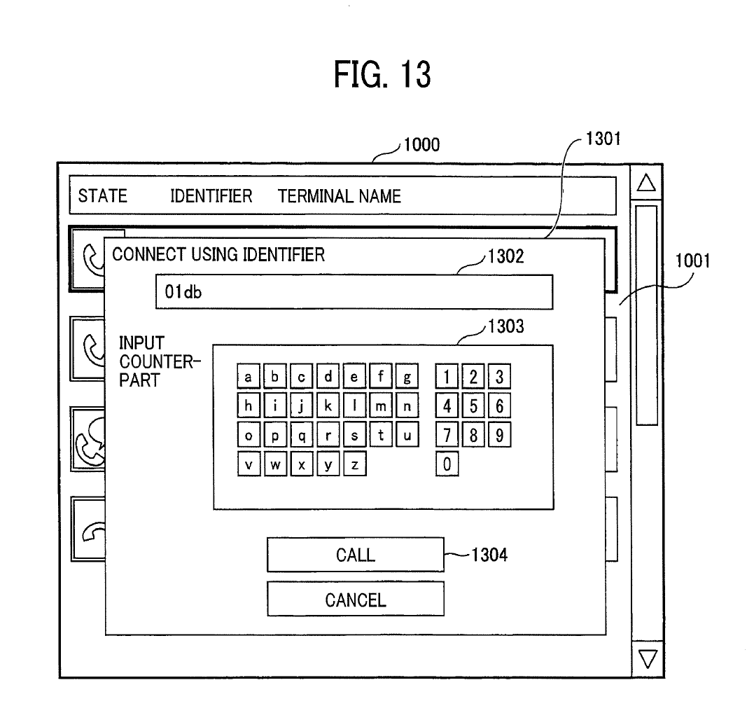

In step S1201, in the state in which the candidate list 1001 illustrated in FIG. 10 is displayed, upon a predetermined operation performed by a user being accepted, the acceptor 19 of the terminal 10 causes, for example, an identifier-based calling screen 1301 illustrated in FIG. 13 to be displayed on the display unit 1000.

In the example illustrated in FIG. 13, the identifier-based calling screen 1301 is displayed as a popup over the candidate list 1001 displayed on the display unit 1000 of the terminal 10. The identifier-based calling screen 1301 includes an identifier input box 1302, a software keyboard 1303 for inputting an identifier, a “call” key 1304, a “cancel” key, and the like.

Into the identifier input box 1302, a user inputs the identifier of a counterpart terminal with which the user wishes to communicate by using the software keyboard 1303 and selects the “call” key 1304, thereby performing a calling operation for the counterpart terminal.

In step S1202 in FIG. 12, the acceptor 19 of the terminal 10 accepts, for example, the calling operation performed by a user by using an identifier on the identifier-based calling screen 1301 illustrated in FIG. 13.

In step S1203, the acceptor 19 of the terminal 10 determines whether the accepted identifier (terminal information of the counterpart terminal) is present (included) in the candidate list generated by the generator 18 (or the candidate list 1001 displayed on the display unit 1000 by the display control 17).

Note that, although an example in which the terminal 10 determines in step S1203 whether the accepted identifier is present (included) in the candidate list is described, the accepted identifier can be transmitted to the management system 50, and the management system 50 can determine whether the accepted identifier is present (included) in the candidate list.

If the accepted identifier is not present in the candidate list (if the accepted identifier is not the candidate identifier), the acceptor 19 of the terminal 10 proceeds to step S1204.

On the other hand, if the accepted identifier is present in the candidate list (if the accepted identifier is the candidate identifier), the acceptor 19 of the terminal 10 proceeds to step S1205

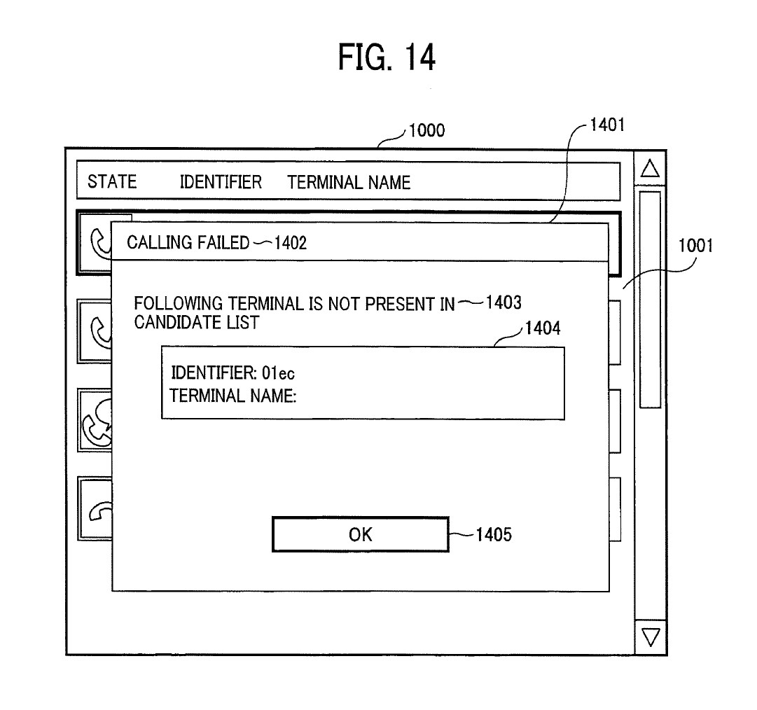

In step S1204, the display control 17 of the terminal 10, for example, causes a dialog (exemplary display screen) 1401 illustrated in FIG. 14 to be displayed on the display unit 1000, the dialog 1401 indicating that the accepted identifier is not present in the candidate list.

In the example in FIG. 14, the dialog 1401 includes a message 1402 indicating that calling has failed, a message 1403 indicating that the designated terminal 10 is not present in the candidate list, information about a designated identifier 1404, and the like. Referring to the dialog 1401, a user can immediately and easily determine that the terminal 10 with which the user wishes to communicate has not been registered in the candidate list. By selecting an “OK” key 1405 in the dialog 1401, the user can terminate the displaying of the dialog 1401.

In step S1205 in FIG. 12, a selection key for selecting the counterpart terminal corresponding to the accepted identifier receives focus under control of the display control 17 of the terminal 10 in the candidate list 1001 displayed on the display unit 1000. Note that, as described above, focus is an exemplary method for displaying a candidate identifier of a terminal 10 selected as a communication counterpart in a distinguishable (emphasized) manner in the candidate list.

In addition, displaying in a distinguishable (emphasized) manner means displaying the accepted identifier in such a manner that it is understood that the identifier is included in the list. Thus, for example, the identifier itself may be displayed to be distinguishable, or a message such as “included in list” may be displayed to be distinguishable.

Through the above process, the counterpart terminal corresponding to the identifier accepted in step S1202 is automatically selected from the candidate list 1001 displayed on the display unit 1000 and displayed in a manner that a calling operation is possible. Thus, a user can, for example, easily perform a calling operation again. Note that this process (step S1205) is a preferred example and is not necessary.

In this embodiment, if it is determined that the accepted identifier is included in the candidate list, on the basis of the state information of the candidate terminal received by the data transmitter/receiver 11 from the management system 50, the data transmitter/receiver 11 of the terminal 10 performs a request process 1220 in steps S1206 to S1212.

In step S1206, the data transmitter/receiver 11 of the terminal 10 determines whether the operating state of the candidate terminal using the accepted identifier is an “online” state. If the operating state of the candidate terminal using the accepted identifier is not an “online” state, the data transmitter/receiver 11 proceeds to step S1207. On the other hand, if the operating state of the candidate terminal using the accepted identifier is an “online” state, the data transmitter/receiver 11 proceeds to step S1208.

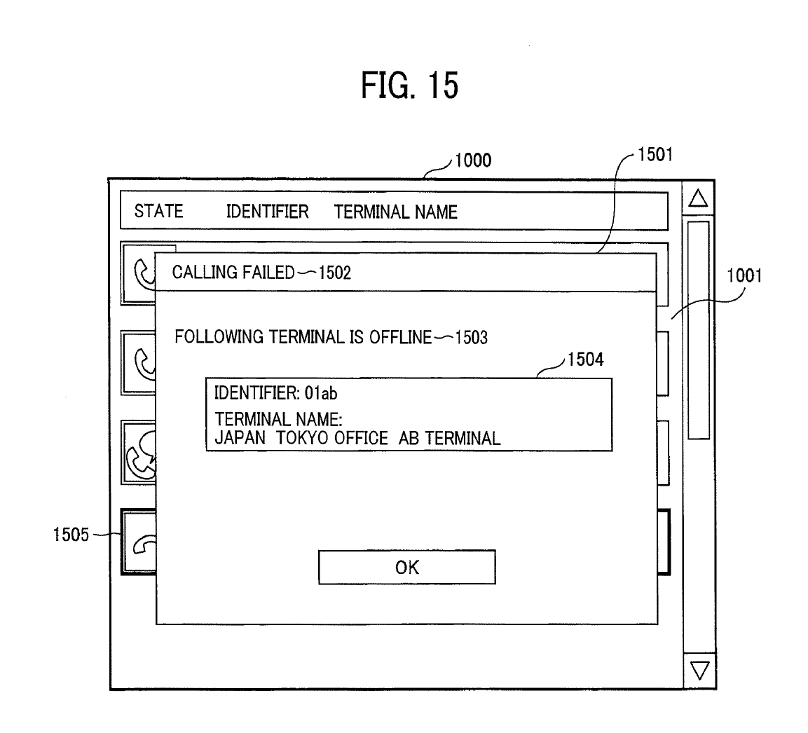

In step S1207, the display control 17 of the terminal 10 causes, for example, a dialog (exemplary display screen) 1501 illustrated in FIG. 15 to be displayed on the display unit 1000, the dialog 1501 indicating that the candidate terminal using the accepted identifier is offline.

In the example in FIG. 15, the dialog 1501 includes a message 1502 indicating that calling has failed, a message 1503 indicating that the terminal 10 using the accepted identifier is offline, information 1504 about the terminal 10 using the accepted identifier, and the like. Referring to the dialog 1501, a user can determine that the counterpart terminal with which the user wishes to communicate is offline and can determine the terminal name and the like of the counterpart terminal.

In the example in FIG. 15, in the candidate list 1001 displayed on the display unit 1000, a key 1505 for selecting a candidate terminal using the accepted identifier “01ab” receives focus. Thus, for example, when the candidate terminal using the accepted identifier “01ab” comes online, a user can easily determine that the candidate terminal is online and can perform a calling operation again.

In step S1208 in FIG. 12, the data transmitter/receiver 11 of the terminal 10 determines whether the candidate terminal using the accepted identifier is performing a conference. For example, if the operating state of the candidate terminal using the accepted identifier is “communicating”, the data transmitter/receiver 11 determines that the candidate terminal is performing a conference; if the operating state thereof is “capable of communicating”, the data transmitter/receiver 11 determines that the candidate terminal is not performing a conference.

If it is determined that the candidate terminal using the accepted identifier is performing a conference, that is, if the operating state thereof is “communicating”, the data transmitter/receiver 11 proceeds to step S1209. On the other hand, if it is determined that the candidate terminal using the accepted identifier is not performing a conference, that is, if the operating state thereof is “capable of communicating”, the data transmitter/receiver 11 proceeds to step S1211.

In step S1209, the data transmitter/receiver 11 of the terminal 10 transmits, for example, to the management system 50 through the communication control 13, participation request information for requesting participation in the conference (communication session) performed by the candidate terminal using the accepted identifier.

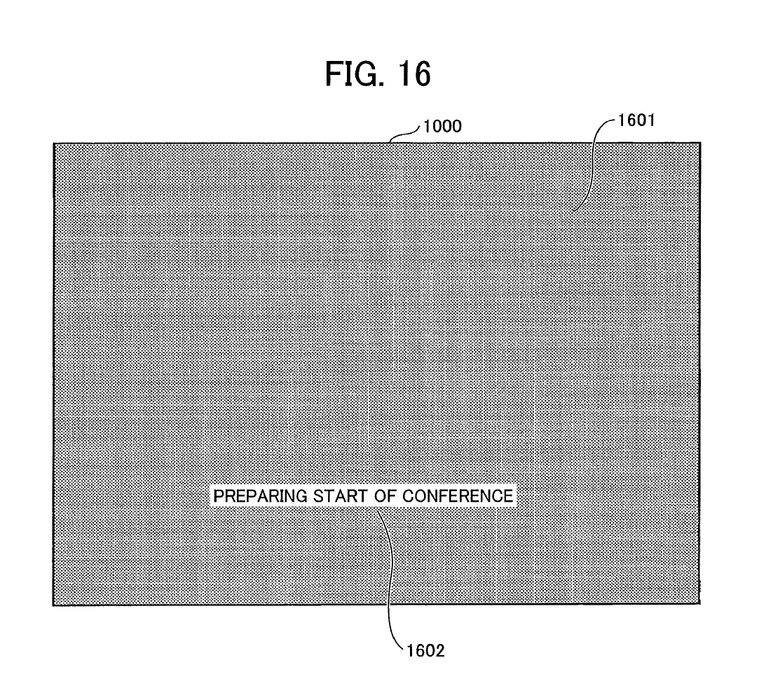

In step S1210, the display control 17 of the terminal 10 causes, for example, a conference preparatory screen (communication preparatory screen) 1601 illustrated in FIG. 16 to be displayed on the display unit 1000.

In the example in FIG. 16, a message 1602 indicating that the start of a conference is being prepared is displayed on the conference preparatory screen 1601. In this manner, upon the participation request information being transmitted to the management system 50, the terminal 10, for example, starts to prepare a conference without a user's confirmation. This conference preparatory screen 1601 is displayed until, for example, a communication session with the counterpart terminal is established. Thus, if, for example, the communication session is immediately established, the terminal 10 may skip the displaying of the conference preparatory screen 1601 illustrated in FIG. 16 and may display a conference screen (communication screen) on the display unit 1000.

In step S1211, the data transmitter/receiver 11 of the terminal 10 transmits, for example, to the management system 50 through the communication control 13, start request information for requesting the start of communication with the candidate terminal using the accepted identifier. Thus, for example, the communication process illustrated in FIG. 11 is performed.

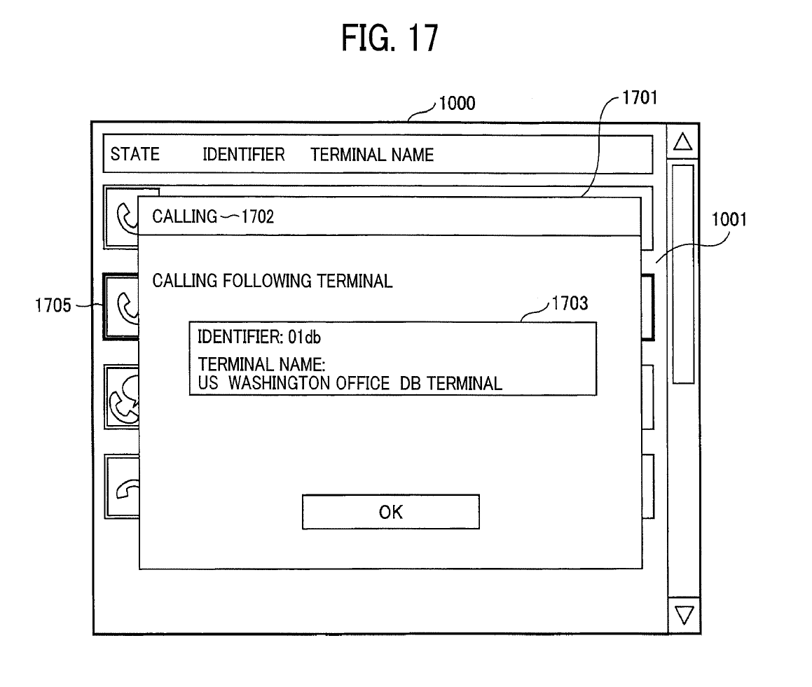

In step S1212, the display control 17 of the terminal 10 causes, for example, a dialog (exemplary display screen) 1701 illustrated in FIG. 17 to be displayed on the display unit 1000, the dialog 1701 indicating that a calling operation is being performed. In the example in FIG. 17, the dialog 1701 includes a message 1702 indicating that the calling operation is being performed, information 1703 about the terminal 10 using the accepted identifier, and the like. Referring to the dialog 1701, a user can determine that the calling operation is being performed for the counterpart terminal and can determine information (e.g., the terminal name) about the terminal 10 using the identifier and the like.

In addition, in the example in FIG. 17, in the candidate list 1001 displayed on the display unit 1000, a key 1705 for selecting the candidate terminal using the accepted identifier “01db” also receives focus. Thus, for example, a user can easily call the candidate terminal using the accepted identifier “01db” again when the user temporarily exits from a conference or when the communication is unintentionally ended, for example.

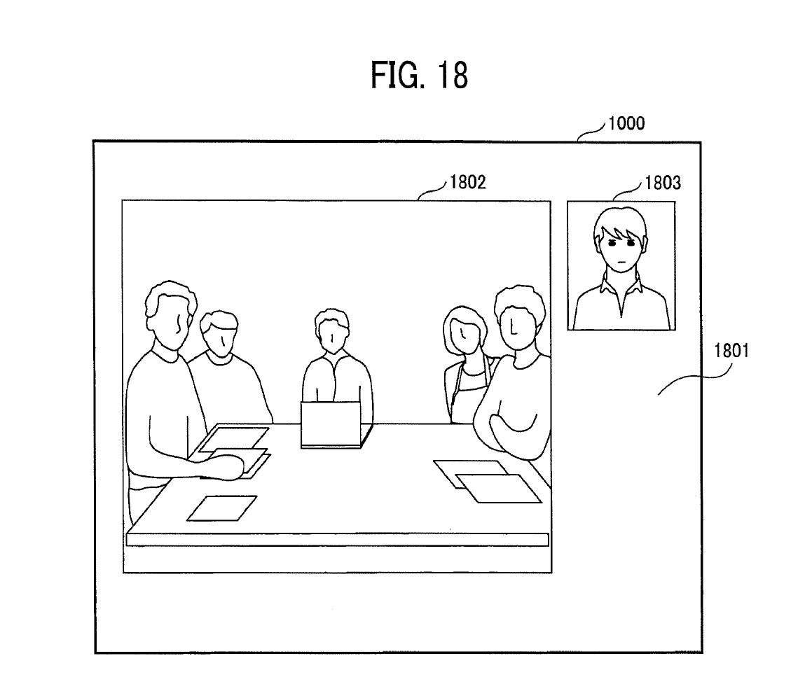

In step S1213, upon a communication session with the counterpart terminal being established, the display control 17 of the terminal 10, for example, causes a conference screen (communication screen) 1801 illustrated in FIG. 18 to be displayed on the display unit 1000.

In the example in FIG. 18, on the conference screen 1801, a conference image 1802 at a distant location received from the counterpart terminal, a conference image 1803 at the location of the terminal 10 captured by the image capturer 14 of the terminal 10, and the like are displayed. Note that the conference screen 1801 illustrated in FIG. 18 is exemplary video data (content data) used for communication in a communication session.

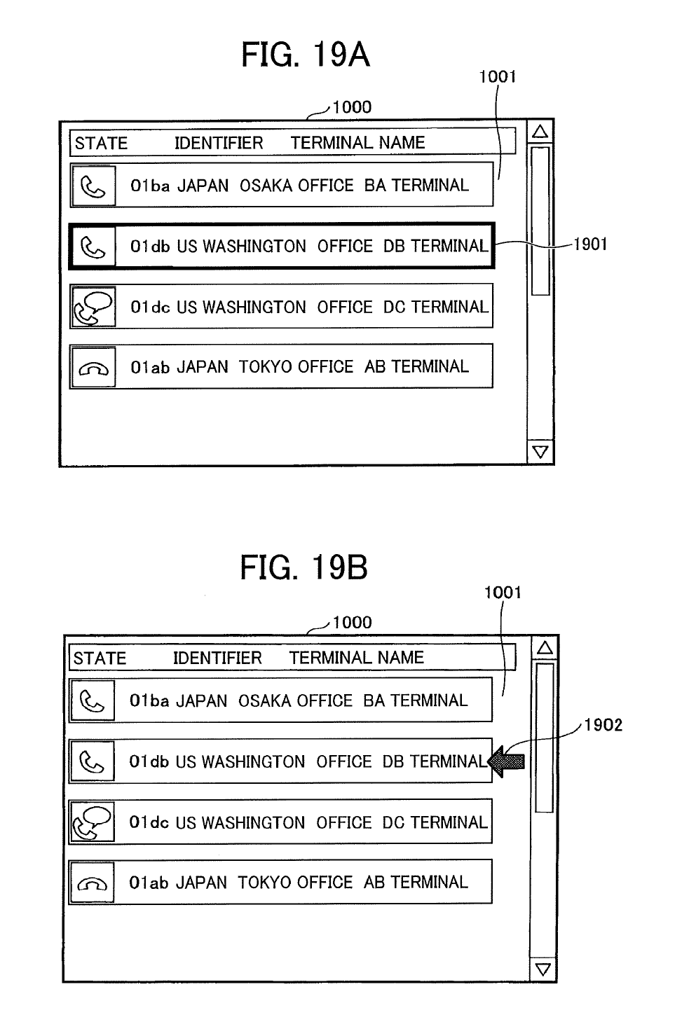

In addition, upon ending the communication with the counterpart terminal, the display control 17 of the terminal 10, for example, causes the candidate list 1001 illustrated in FIG. 19A to be displayed on the display unit 1000 again. In the candidate list 1001 illustrated in FIG. 19, a selection key for selecting the counterpart terminal with which communication has been performed is selected and receives focus, as indicated by a bold frame 1901. Note that the bold frame 1901 is an exemplary display component indicating that a selection key is selected. The display component indicating that a selection key is selected may be another display component such as a block arrow 1902 illustrated in FIG. 19B, for example.

In the above manner, if a communication start operation using an identifier is accepted, and if the candidate list includes a candidate terminal using the accepted identifier, the terminal 10 according to this embodiment transmits to the management system 50, request information for requesting the start of communication, based on the state information of the candidate terminal.

Thus, with the terminal 10 according to this embodiment, a user can skip an operation for selecting from the candidate list, a counterpart terminal to communicate with, and accordingly, the user can immediately start to communicate with another terminal by using the terminal 10.

In addition, if the counterpart terminal is capable of communicating (“capable of communicating” or “communicating”) based on the state information of the candidate terminal that has been acquired in advance, the terminal 10 according to this embodiment requests the management system 50 to start communication. Thus, for example, even if the number of terminals 10 increases, the load on the management system 50 and the communication network 2 can be reduced.

Furthermore, if the candidate list 1001 includes a candidate terminal using the accepted identifier, the terminal 10 according to this embodiment displays a selection key for selecting the candidate terminal using the accepted identifier in the candidate list 1001 in such a manner that the selection key receives focus. Thus, a user can immediately and easily call the counterpart terminal from the terminal 10 again.

### Second Embodiment

In a second embodiment, another exemplary calling process performed by the terminal 10 will be described.

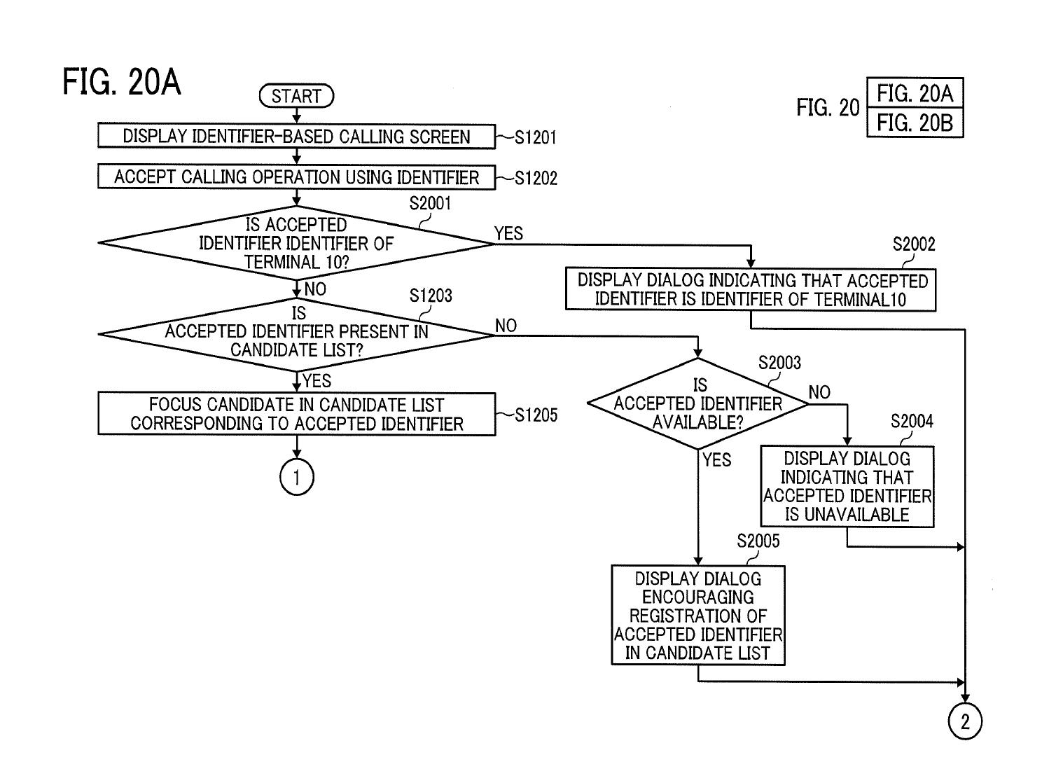

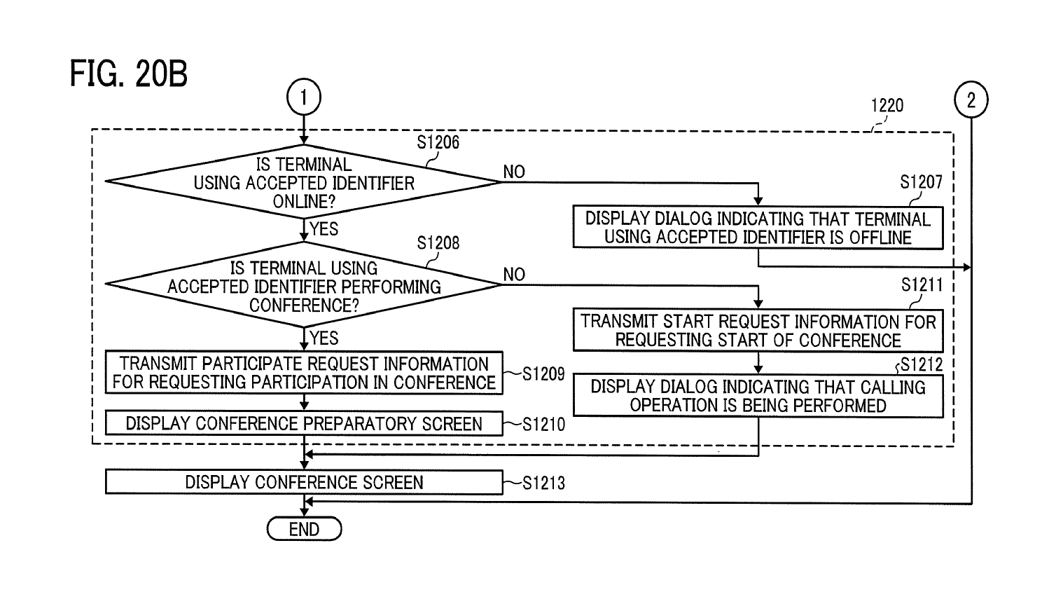

FIG. 20 illustrates an exemplary terminal calling process according to the second embodiment. Note that the process in steps S1201 to S1203 and steps S1205 to S1213 in FIG. 20 is substantially the same as the terminal calling process illustrated in FIG. 12 according to the first embodiment, and therefore, different points from the first embodiment will mainly be described in this embodiment.

In step S2001, the acceptor 19 of the terminal 10 determines whether the identifier accepted in step S1202 is the identifier of the terminal 10.

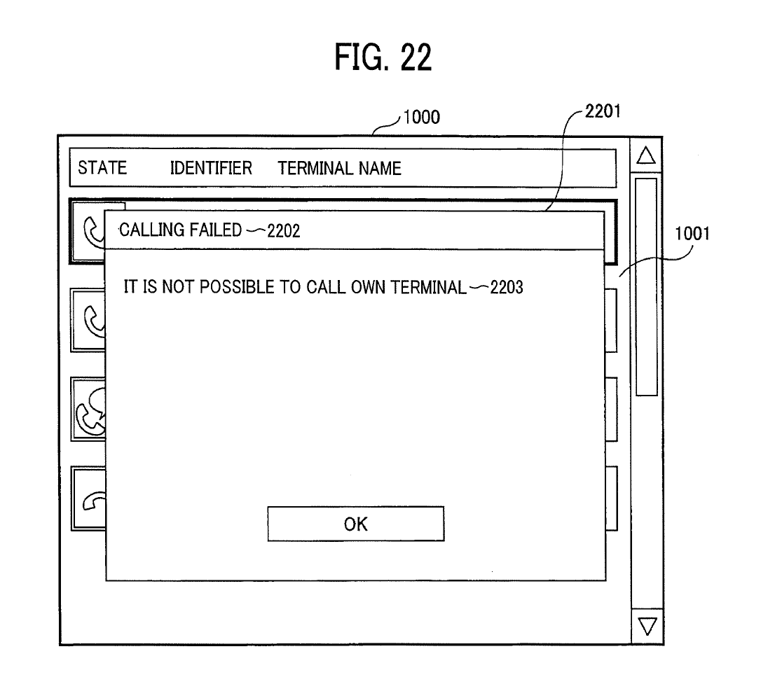

If it is determined that the accepted identifier is not the identifier of the terminal 10, the terminal 10 performs the process in and after step S1203 described in the first embodiment. On the other hand, if it is determined that the accepted identifier is the identifier of the terminal 10, the acceptor 19 of the terminal 10 proceeds to step S2002. In step S2002, the display control 17 of the terminal 10 causes, for example, a dialog 2201 illustrated in FIG. 22 to be displayed on the display unit 1000, the dialog 2201 indicating that the accepted identifier is the identifier of the terminal 10.

In the example illustrated in FIG. 22, the dialog 2201 includes a message 2202 indicating that calling has failed, a message 2203 indicating that the accepted identifier is the identifier of the terminal 10, and the like.

Through this process, the terminal 10 can skip the process in and after step S1203 if a calling operation for the identifier of the terminal 10 is accepted, and the terminal 10 can immediately notify a user that calling is not possible.

In addition, if it is determined in step S1203 in FIG. 20 that the accepted identifier is not present in the candidate list, the terminal 10 according to this embodiment performs the process in steps S2003 to S2005.

In step S2003, the acceptor 19 of the terminal 10 determines whether the accepted identifier is available in the management system 50 (whether the accepted identifier has been registered in the management system 50). For example, by using the inquirer 21, the acceptor 19 makes an inquiry to the management system 50 about whether the accepted identifier is available in the management system 50.

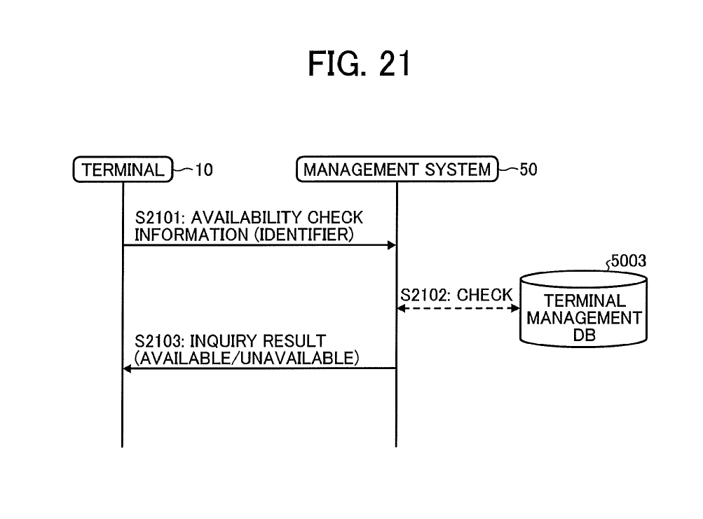

FIG. 21 illustrates a sequence of an exemplary inquiry process according to the second embodiment.

In step S2101, the inquirer 21 of the terminal 10 transmits to the management system 50, availability inquiry information for inquiring whether the accepted identifier is available in the management system 50.

In step S2102, the terminal manager 53 of the management system 50 checks whether the identifier of interest has been registered in, for example, the terminal management table 801 illustrated in FIG. 8A stored in the terminal management DB 5003.

In step S2103, the terminal manager 53 of the management system 50 transmits the inquiry result to the terminal 10. For example, if an identifier included in the availability inquiry information has been registered in the terminal management table 801, the terminal manager 53 of the management system 50 transmits an inquiry result of “available” to the terminal 10. On the other hand, if an identifier included in the availability inquiry information has not been registered in the terminal management table 801, the terminal manager 53 of the management system 50 transmits an inquiry result of “unavailable” to the terminal 10.

Referring back to FIG. 20, the terminal calling process will be further described.

In step S2003, the acceptor 19 of the terminal 10 determines, for example, whether the accepted identifier is available in the management system 50, based on the inquiry result from the management system 50.

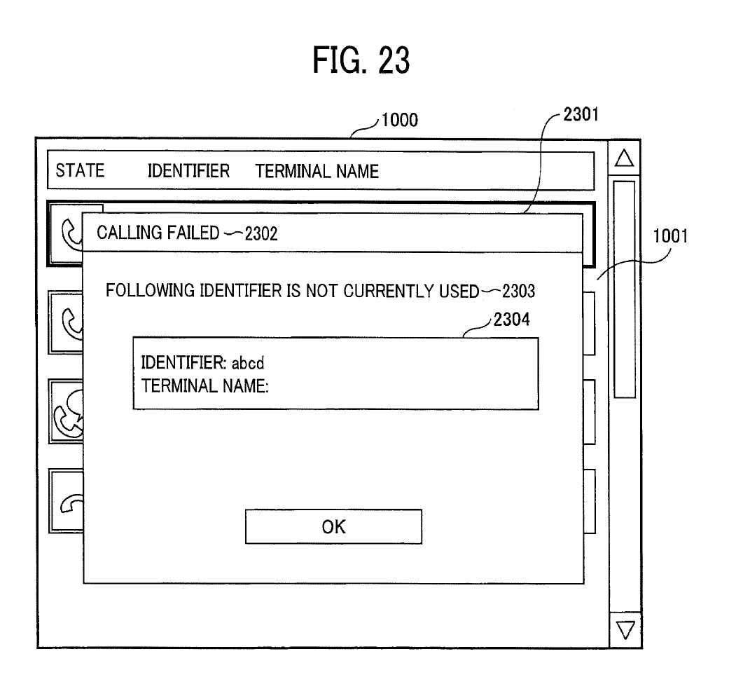

If it is determined that the accepted identifier is unavailable in the management system 50, in step S2004, the display control 17 of the terminal 10 causes a dialog 2301 illustrated in FIG. 23 to be displayed on the display unit 1000, the dialog 2301 indicating that the accepted identifier is unavailable.

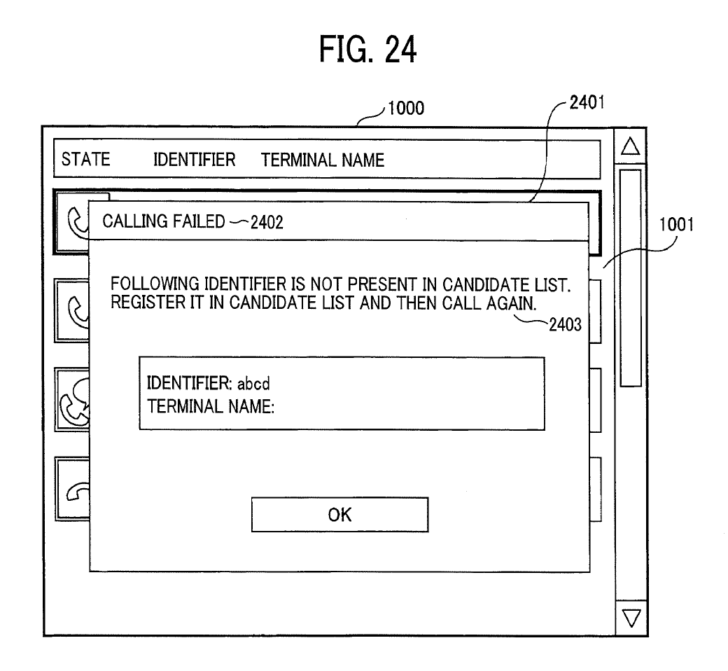

On the other hand, if it is determined that the accepted identifier is available in the management system 50, in step S2005, the display control 17 of the terminal 10 causes a dialog 2401 illustrated in FIG. 24 to be displayed on the display unit 1000, the dialog 2401 encouraging a user to register the accepted identifier in the candidate list.

In the example illustrated in FIG. 23, the dialog 2301 indicating that the accepted identifier is unavailable includes a message 2302 indicating that calling has failed, a message 2303 indicating that the identifier is unavailable, information 2304 about the identifier, and the like.

Referring to the dialog 2301, a user can determine that the identifier used for the calling operation has not been registered in the candidate list and is unavailable in the management system 50 (incapable of being registered in the candidate list).

In the example illustrated in FIG. 24, the dialog 2401 encouraging a user to register the accepted identifier in the candidate list includes a message 2402 indicating that calling has failed, a message 2403 encouraging a user to register the identifier in the candidate list, and the like.

Referring to the dialog 2401, a user can determine that the identifier needs to be registered in the candidate list in order to call the identifier used for the calling operation.

Note that in step S2003, the acceptor 19 of the terminal 10 may, for example, determine whether the accepted identifier is available, on the basis of a list of identifiers that have been registered in the management system 50, the list being stored in the memory 24 in advance, without using the inquirer 21.

As described above, according to one or more of the above embodiments, in the communication system 1 in which communication with a communication counterpart terminal is started by using a candidate list, the user can immediately start communication with another terminal by using a terminal (information processing terminal) 10.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

For example, while the above-described embodiment assumes that the candidate identifier is input in terms of a terminal ID, any other type of identification information of the counterpart terminal may be input by the user. Examples of such identification information include, but not limited to, a user name who operates the counterpart terminal.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing terminal, comprising:
a receiver to receive from a management system via a network, a candidate identifier of each one of one or more candidate counterpart information processing terminals that are previously registered for the information processing terminal; and
circuitry to control a display to display a candidate list including the candidate identifiers,
wherein the circuitry determines, in response to acceptance of an identifier that has been input, whether the accepted identifier matches any one of the candidate identifiers on the candidate list, and
when the accepted identifier matches one of the candidate identifiers, the circuitry causes the candidate identifier that matches the accepted identifier to be displayed differently from other candidate identifies on the candidate list, such that the candidate identifier that matches the accepted identifier is noticeable.

2. The information processing terminal according to claim 1,
wherein, when the accepted identifier does not match any one of the candidate identifiers on the candidate list, the circuitry controls the display to further display information indicating that the accepted identifier is not the candidate identifier on the candidate list.

3. The information processing terminal according to claim 1, further comprising:
a transmitter to transmit request information for requesting the management system to start communication with the candidate counterpart information processing terminal identified with the candidate identifier, when the accepted identifier matches one of the candidate identifiers on the candidate list.

4. The information processing terminal according to claim 3,
wherein the receiver receives state information of the candidate counterpart information processing terminal identified with the candidate identifier, and
wherein, when the received state information indicates that the candidate counterpart information processing terminal is not available to start communication, the transmitter suspends transmission of the request information for requesting the management system to start communication.

5. The information processing terminal according to claim 4,
wherein, when the received state information indicates that the candidate counterpart information processing terminal is not available to start communication, the circuitry controls the display to display a display screen, the display screen indicating that the candidate counterpart information processing terminal identified with the candidate identifier is not available to start communication.

6. The information processing terminal according to claim 3,
wherein the receiver receives state information of the candidate counterpart communication terminal identified with the candidate identifier, and
wherein, when the received state information indicates that the candidate counterpart information processing terminal identified with the candidate identifier is currently communicating, the transmitter transmits to the management system, participation request information for requesting participation in communication.

7. The information processing terminal according to claim 6,
wherein, when the received state information indicates that the candidate counterpart information processing terminal identified with the candidate identifier is currently communicating, the circuitry controls the display to display one of:
a communication screen for allowing a user to start communication with the candidate counterpart information processing terminal; and
a communication preparatory screen indicating that the communication is being prepared.

8. The information processing terminal according to claim 3,
wherein the receiver receives state information of the candidate counterpart information processing terminal identified with the candidate identifier, and
wherein, when the received state information indicates that the candidate counterpart information processing terminal identified with the candidate identifier is available for communication, the transmitter transmits to the management system, start request information for requesting start of communication with the candidate counterpart information processing terminal.

9. The information processing terminal according to claim 8,
wherein, when the received state information indicates that the candidate counterpart information processing terminal identified with the candidate identifier is available for communication, the circuitry controls the display to display a display screen, the display screen indicating that a calling operation for the candidate counterpart information processing terminal is being performed.

10. The information processing terminal according to claim 1,
wherein, when the accepted identifier does not match any one of the candidate identifiers on the candidate list, the circuitry controls the display to display a display screen, the display screen encouraging a user to register the candidate identifier that has been input in the candidate list.

11. A communication system comprising:
the information processing terminal according to claim 1; and
a management system to control communication to be performed between the information processing terminal and the one or more candidate counterpart communication terminals via a network, the management system including:
a memory to store, for each one of one or more information processing terminals being managed by the communication system, candidate identifiers of one or more candidate counterpart information processing terminals; and
a transmitter to transmit, to the information processing terminal, the candidate identifiers of the candidate counterpart information processing terminals registered for the information processing terminal.

12. The communication system according to claim 11,
wherein the memory of the management system further stores, for each one of the one or more information processing terminals, state information indicating a state of the information processing terminal.

13. The communication system according to claim 12,
wherein the memory of the management system further stores information to be used for managing a session established between the information processing terminal and at least one of the one or more candidate counterpart communication terminals.

14. The information processing terminal according to claim 1,
wherein the circuitry further controls the display to display a screen for allowing a user to input the identifier, as the candidate identifier of the candidate counterpart information processing terminal for the information processing terminal.

15. The information processing terminal according to claim 1,
wherein the candidate identifier that matches the accepted identifier is displayed in a graphical image having an appearance different from an appearance of a graphical image of the other candidate identifiers on the candidate list.

16. An information processing method, comprising:
receiving from a management system via a network, a candidate identifier of each one of one or more candidate counterpart information processing terminals that are previously registered for the information processing terminal;
controlling a display to display a candidate list including the candidate identifiers;
determining, in response to acceptance of an identifier that has been input, whether the accepted identifier matches any one of the candidate identifies on the candidate list; and
when the determining determines that the accepted identifier matches one of the candidate identifiers, displaying the candidate identifier that matches the accepted identifier differently from other candidate identifies on the candidate list, such that the candidate identifier that matches the accepted identifier is noticeable.

17. A non-transitory recording medium which, when executed by one or more processors, cause the processors to perform an information processing method comprising:
receiving from a management system via a network, a candidate identifier of each one of one or more candidate counterpart information processing terminals that are previously registered for the information processing terminal;
controlling a display to display a candidate list including the candidate identifiers;
determining, in response to acceptance of an identifier that has been input, whether the accepted identifier matches any one of the candidate identifies on the candidate list; and
when the determining determines that the accepted identifier matches one of the candidate identifiers, displaying the candidate identifier that matches the accepted identifier differently from other candidate identifies on the candidate list, such that the candidate identifier that matches the accepted identifier is noticeable.
